(19) United States
(12) Patent Application Publication
(10) Pub. No.: US 2026/0025843 A1
(43) Pub. Date: Jan. 22, 2026

(54) BLOCK DECOMPOSITION CONFIGURATIONS FOR SUCCESSIVE INTERFERENCE CANCELLATION

(71) Applicant: QUALCOMM Incorporated, San Diego, CA (US)

(72) Inventors: Kirill IVANOV, La Jolla, CA (US); Wei YANG, San Diego, CA (US); Pinar SEN, San Diego, CA (US); Jing JIANG, San Diego, CA (US); Yu ZHANG, San Diego, CA (US)

(21) Appl. No.: 18/778,760

(22) Filed: Jul. 19, 2024

(51) Int. Cl. H04W 72/541; H04L 5/00

(52) U.S. Cl. CPC H04W 72/541; H04L 5/0016; H04L 5/0053

(57) ABSTRACT

Methods, systems, and devices for wireless communications are described. A user equipment (UE) may transmit, to a network entity, a channel state information (CSI) report. The UE may receive, based on the CSI report, an indication of a block decomposition configuration for transmission of multiple code blocks associated with at least one code word. Each of the multiple code blocks may be divided into multiple code block parts that are each associated with a respective spatial layer. The block decomposition configuration may indicate a first quantity of code block parts of a code block to be transmitted via a first set of time-frequency resources and may indicate at least a second quantity of code block parts of the code block to be transmitted via a second set of time-frequency resources. The UE may transmit the multiple code blocks in accordance with the block decomposition configuration.

### FIELD OF TECHNOLOGY

The following relates to wireless communications, including block decomposition configurations for successive interference cancellation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, to a network entity, a channel state information report, receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources, and transmitting the set of multiple code blocks in accordance with the block decomposition configuration.

A UE for wireless communications is described. The UE may include one or more memories storing processor executable code, and one or more processors coupled with the one or more memories. The one or more processors may individually or collectively be operable to execute the code to cause the UE to transmit, to a network entity, a channel state information report, receive, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources, and transmit the set of multiple code blocks in accordance with the block decomposition configuration.

Another UE for wireless communications is described. The UE may include means for transmitting, to a network entity, a channel state information report, means for receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources, and means for transmitting the set of multiple code blocks in accordance with the block decomposition configuration.

A non-transitory computer-readable medium storing code for wireless communications is described. The code may include instructions executable by one or more processors to transmit, to a network entity, a channel state information report, receive, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources, and transmit the set of multiple code blocks in accordance with the block decomposition configuration.

In some examples of the method, UEs, and non-transitory computer-readable medium described herein, receiving the indication of the block decomposition configuration may include operations, features, means, or instructions for receiving the indication of the block decomposition configuration via a downlink control information (DCI) message, via a medium access control-control element (MAC-CE), or via a radio resource control (RRC) message.

In some examples of the method, UEs, and non-transitory computer-readable medium described herein, transmitting the channel state information report may include operations, features, means, or instructions for transmitting an indication of a requested block decomposition configuration, where the received indication of a block decomposition configuration may be based on the transmitted requested block decomposition configuration.

In some examples of the method, UEs, and non-transitory computer-readable medium described herein, the requested block decomposition configuration may be associated with a reported rank in the channel state information report.

In some examples of the method, UEs, and non-transitory computer-readable medium described herein, transmitting the channel state information report may include operations, features, means, or instructions for transmitting an indication of a threshold throughput supported by the UE, a threshold bandwidth supported by the UE, or both for one or more of a set of multiple block decomposition configurations, where receiving the indication of the block decomposition configuration may be based on transmitting the indication.

In some examples of the method, UEs, and non-transitory computer-readable medium described herein, receiving the indication of the block decomposition configuration may include operations, features, means, or instructions for receiving, based on a quantity of spatial layers exceeding a threshold, an indication of a first block decomposition configuration for a first code word and a second block decomposition configuration for a second code word.

In some examples of the method, UEs, and non-transitory computer-readable medium described herein, the first block decomposition configuration may be a same as the second block decomposition configuration based on the quantity of spatial layers being an even number.

In some examples of the method, UEs, and non-transitory computer-readable medium described herein, the first block decomposition configuration, the second block decomposition configuration, or both includes a trivial decomposition in which each of the code block parts of a code block of the set of multiple code blocks may be to be transmitted via the first set of time-frequency resources.

A method for wireless communications by a network entity is described. The method may include selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources and outputting the set of multiple code blocks in accordance with the block decomposition configuration.

A network entity for wireless communications is described. The network entity may include one or more memories storing processor executable code, and one or more processors coupled with the one or more memories. The one or more processors may individually or collectively be operable to execute the code to cause the network entity to select a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources and output the set of multiple code blocks in accordance with the block decomposition configuration.

Another network entity for wireless communications is described. The network entity may include means for selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources and means for outputting the set of multiple code blocks in accordance with the block decomposition configuration.

A non-transitory computer-readable medium storing code for wireless communications is described. The code may include instructions executable by one or more processors to select a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources and output the set of multiple code blocks in accordance with the block decomposition configuration.

In some examples of the method, network entities, and non-transitory computer-readable medium described herein, selecting the block decomposition configuration may include operations, features, means, or instructions for selecting the block decomposition configuration from a set of multiple block decomposition configurations associated with a quantity of spatial layers.

In some examples of the method, network entities, and non-transitory computer-readable medium described herein, the set of multiple block decomposition configurations includes a trivial decomposition in which each of the code block parts of a code block of the set of multiple code blocks may be to be output via the first set of time-frequency resources.

In some examples of the method, network entities, and non-transitory computer-readable medium described herein, selecting the block decomposition configuration may include operations, features, means, or instructions for obtaining a channel state information report and selecting the block decomposition configuration based on the channel state information report.

Some examples of the method, network entities, and non-transitory computer-readable medium described herein may further include operations, features, means, or instructions for obtaining an indication of a requested block decomposition configuration, where selecting the block decomposition configuration may be based on the indication.

Some examples of the method, network entities, and non-transitory computer-readable medium described herein may further include operations, features, means, or instructions for outputting an indication of the selected block decomposition configuration via a DCI message, via a medium access control-control element (MAC-CE), or via an RRC message.

Some examples of the method, network entities, and non-transitory computer-readable medium described herein may further include operations, features, means, or instructions for obtaining, from a UE, an indication of a threshold throughput supported by the UE, a threshold bandwidth supported by the UE, or both for one or more of a set of multiple block decomposition configurations, where the block decomposition configuration may be selected based on obtaining the indication.

In some examples of the method, network entities, and non-transitory computer-readable medium described herein, selecting the block decomposition configuration may include operations, features, means, or instructions for selecting, based on a quantity of spatial layers exceeding a threshold, a first block decomposition configuration for a first code word and a second block decomposition configuration for a second code word.

In some examples of the method, network entities, and non-transitory computer-readable medium described herein, the first block decomposition configuration may be a same as the second block decomposition configuration based on the quantity of spatial layers being an even number.

In some examples of the method, network entities, and non-transitory computer-readable medium described herein, the first block decomposition configuration, the second block decomposition configuration, or both includes a trivial decomposition in which each of the code block parts of a code block of the set of multiple code blocks may be to be output via the first set of time-frequency resources.

A method for wireless communications by a UE is described. The method may include receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources and successively decoding the first set of time-frequency resources and the second set of time-frequency resources in accordance with the block decomposition configuration.

A UE for wireless communications is described. The UE may include one or more memories storing processor executable code, and one or more processors coupled with the one or more memories. The one or more processors may individually or collectively be operable to execute the code to cause the UE to receive a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources and successively decode the first set of time-frequency resources and the second set of time-frequency resources in accordance with the block decomposition configuration.

Another UE for wireless communications is described. The UE may include means for receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources and means for successively decoding the first set of time-frequency resources and the second set of time-frequency resources in accordance with the block decomposition configuration.

A non-transitory computer-readable medium storing code for wireless communications is described. The code may include instructions executable by one or more processors to receive a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources and successively decode the first set of time-frequency resources and the second set of time-frequency resources in accordance with the block decomposition configuration.

In some examples of the method, UEs, and non-transitory computer-readable medium described herein, successively decoding the first set of time-frequency resources and the second set of time-frequency resources may include operations, features, means, or instructions for decoding the first quantity of code block parts associated with the first set of time-frequency resources, subtracting the decoded first quantity of code block parts from the a signal carrying the set of multiple code blocks, and decoding the second quantity of code block parts associated with the second set of time-frequency resources.

Some examples of the method, UEs, and non-transitory computer-readable medium described herein may further include operations, features, means, or instructions for subtracting the decoded second quantity of code block parts from the signal carrying the set of multiple code blocks and decoding a third quantity of code block parts associated with a third set of time-frequency resources in accordance with the block decomposition configuration.

Some examples of the method, UEs, and non-transitory computer-readable medium described herein may further include operations, features, means, or instructions for transmitting an indication of a threshold throughput supported by the UE, a threshold bandwidth supported by the UE, or both for one or more of a set of multiple block decomposition configurations, where receiving the set of multiple block codes in accordance with the block decomposition configuration may be based on transmitting the indication.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports block decomposition configurations for successive interference cancellation in accordance with one or more aspects of the present disclosure.

FIG. 2 shows an example of a wireless communications system that supports block decomposition configurations for successive interference cancellation in accordance with one or more aspects of the present disclosure.

FIGS. 3, 4, and 5 show examples of resource diagrams that support block decomposition configurations for successive interference cancellation in accordance with one or more aspects of the present disclosure.

FIGS. 6 and 7 show examples of process flows that support block decomposition configurations for successive interference cancellation in accordance with one or more aspects of the present disclosure.

FIGS. 8 and 9 show block diagrams of devices that support block decomposition configurations for successive interference cancellation in accordance with one or more aspects of the present disclosure.

FIG. 10 shows a block diagram of a communications manager that supports block decomposition configurations for successive interference cancellation in accordance with one or more aspects of the present disclosure.

FIG. 11 shows a diagram of a system including a device that supports block decomposition configurations for successive interference cancellation in accordance with one or more aspects of the present disclosure.

FIGS. 12 and 13 show block diagrams of devices that support block decomposition configurations for successive interference cancellation in accordance with one or more aspects of the present disclosure.

FIG. 14 shows a block diagram of a communications manager that supports block decomposition configurations for successive interference cancellation in accordance with one or more aspects of the present disclosure.

FIG. 15 shows a diagram of a system including a device that supports block decomposition configurations for successive interference cancellation in accordance with one or more aspects of the present disclosure.

FIGS. 16 through 23 show flowcharts illustrating methods that support block decomposition configurations for successive interference cancellation in accordance with one or more aspects of the present disclosure.

### DETAILED DESCRIPTION

In some wireless communications systems, one or more code words (e.g., representing user data) may be partitioned into multiple code blocks. A transmitting wireless device may communicate the one or more code words using a multiple—in multiple-out (MIMO) structure such that the code words are mapped to multiple spatial layers (e.g., communicated using respective antenna elements of the wireless device). For instance, in some wireless communications systems (e.g., long-term evolution (LTE)), different code words may be mapped to different respective layers. For example, a wireless device operating in an LTE system may transmit multiple code blocks of a code word using a single spatial layer over multiple time-frequency resources. In some other wireless systems (e.g., a 5G new radio (NR) system), a single code word may be mapped to multiple layers. For example, a wireless device operating in an NR system may transmit multiple code blocks of a single code word over multiple radio-frequency resources, in some cases using multiple spatial layers in a single time-frequency resource to transmit a same code block or repetitions of a code block. However, such techniques may incur significant signaling overhead (e.g., due to per-layer feedback signaling in an LTE system) or may reduce a receiver's ability to properly decode the code word (e.g., due to nonlinear demodulation across multiple layers in an NR system). Moreover, while some wireless communications systems may implement techniques for spatially coupled MIMO signaling for a single code word across multiple layers (e.g., diagonally across multiple time-frequency resources), additional techniques for a relatively large quantity of layers (e.g., more than two layers), for more than one code word, or for both may be desired.

The described techniques provide for spatially coupled MIMO signaling for a single code word across multiple layers (and may be extended to multiple code words). For example, a transmitting device (e.g., a user equipment (UE) or a network entity) may transmit multiple code blocks associated with a code word in accordance with a block decomposition configuration that groups multiple spatial layers into layer blocks and maps code block parts on the block level. That is, each of the multiple code blocks may be divided into multiple code block parts that are each associated with a respective code block layer. The block decomposition configuration may indicate a first quantity of code block parts of a code block of the multiple code blocks to be transmitted via a first set of resources (e.g., time, frequency, and spatial resources) and may indicate a second quantity of code block parts of the code block of the multiple code blocks to be transmitted via a second set of resources (e.g., time, frequency, and spatial resources). If the transmitting device is a network entity, the network entity may select the block decomposition configuration from a set of multiple block decomposition configurations (e.g., based on a quantity of spatial layers, a channel state information report, or both). If the transmitting device is a UE, the UE may receive an indication of the block decomposition configuration from a network entity. In some examples, the transmitting device may transmit a first code word in accordance with a first block decomposition configuration and may transmit a second code word in accordance with a second block decomposition configuration. The receiving device may successively decode the first set of time-frequency resources and the second set of time-frequency resources in accordance with the block decomposition configuration.

Particular aspects of the subject matter described herein may be implemented to realize one or more potential advantages. The described techniques may provide for reduced processing, improved user experience related to reduced processing, reduced latency, more efficient utilization of communication resources, improved coordination between devices, and improved utilization of processing capability. For example, a network entity may reduce processing at a receiving device (e.g., the network entity or a UE) by selecting a block decomposition configuration such that relatively more code block parts may be demodulated using a simpler demodulator (e.g., a minimum mean square error (MMSE) demodulator) and relatively fewer code block parts may be demodulated using a more complex demodulator (e.g., a per-stream recursive demapping (PSRD) demodulator). The network entity may also select a block decomposition configuration to improve throughput, improve processing speed, reduce latency, realize one or more other benefits, or a combination thereof. Signaling is described to coordinate the transmission and decoding of multiple code blocks of a code word in accordance with a selected block decomposition configuration.

Aspects of the disclosure are initially described in the context of wireless communications systems. Aspects of the disclosure are then described in the context of resource diagrams and process flows. Aspects of the disclosure are further illustrated by and described with reference to apparatus diagrams, system diagrams, and flowcharts that relate to block decomposition configurations for successive interference cancellation.

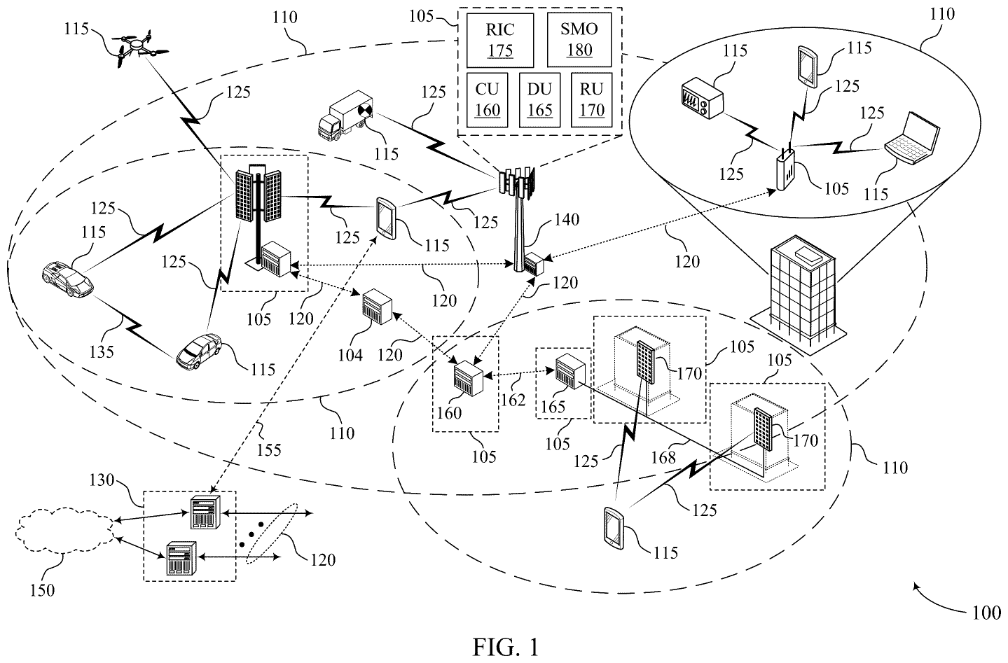

FIG. 1 shows an example of a wireless communications system 100 that supports block decomposition configurations for successive interference cancellation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same code word) or different data streams (e.g., different code words). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In the wireless communications system 100, one or more code words (e.g., user data) may be partitioned into multiple code blocks. A transmitting wireless device may communicate the one or more code words using a MIMO structure such that the code words are mapped to multiple spatial layers (e.g., communicated using respective antenna elements of the wireless device). For instance, in some wireless communications systems (e.g., LTE), different code words may be mapped to different respective layers. For example, a wireless device operating in an LTE system may transmit multiple code blocks of a code word using a single spatial layer over multiple time-frequency resources. In some other wireless systems (e.g., a 5G new radio (NR) system), a single code word may be mapped to multiple layers. For example, a wireless device operating in an NR system may transmit multiple code blocks of a single code word over multiple radio-frequency resources, in some cases using multiple spatial layers in a single time-frequency resource to transmit a same code block or repetitions of a code block. However, such techniques may incur significant signaling overhead (e.g., due to per-layer feedback signaling in an LTE system) or may reduce a receiver's ability to properly decode the code word (e.g., due to nonlinear demodulation across multiple layers in an NR system). Moreover, while some wireless communications systems may implement techniques for spatially coupled MIMO signaling for a single code word across multiple layers (e.g., diagonally across multiple time-frequency resources), additional techniques for a relatively large quantity of layers (e.g., more than two layers), for more than one code word, or for both may be desired.

The described techniques provide for spatially coupled MIMO signaling for a single code word across multiple layers (and may be extended to multiple code words). For example, a transmitting device (e.g., a UE 115 or a network entity 105) may transmit (e.g., via a communication link 125) multiple code blocks associated with a code word in accordance with a block decomposition configuration that groups multiple spatial layers into layer blocks and diagonally maps code block parts on the block level. That is, each of the multiple code blocks may be divided into multiple code block parts that are each associated with a respective code block layer. The block decomposition configuration may indicate a first quantity of code block parts of a code block of the multiple code blocks to be transmitted via a first set of time-frequency resources and may indicate a second quantity of code block parts of the code block of the multiple code blocks to be transmitted via a second set of time-frequency resources. If the transmitting device is a network entity 105, the network entity 105 may select the block decomposition configuration from a set of multiple block decomposition configurations (e.g., based on a quantity of spatial layers, a channel state information report, or both). If the transmitting device is a UE 115, the UE 115 may receive an indication of the block decomposition configuration from a network entity. In some examples, the transmitting device may transmit a first code word in accordance with a first block decomposition configuration and may transmit a second code word in accordance with a second block decomposition configuration. A receiving device (e.g., a UE 115 or a network entity 105) may successively decode the first set of time-frequency resources and the second set of time-frequency resources in accordance with the block decomposition configuration.

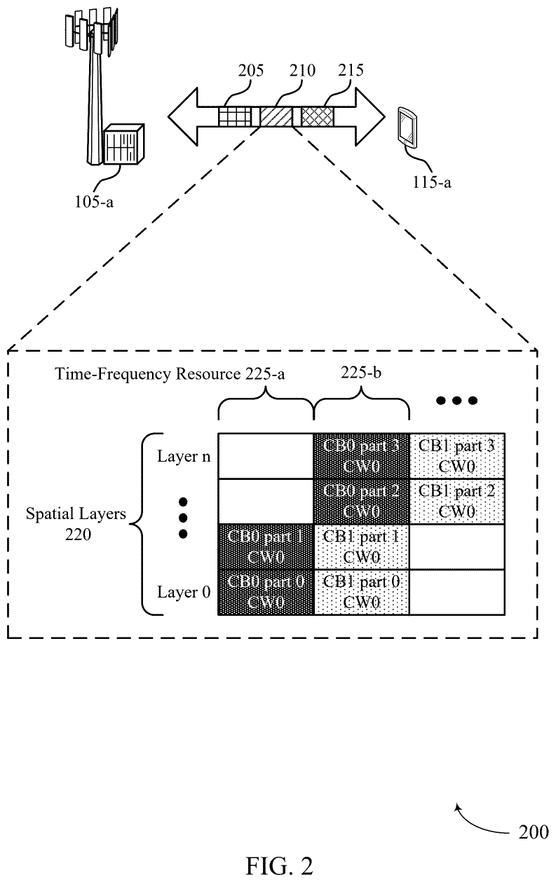

FIG. 2 shows an example of a wireless communications system 200 that supports block decomposition configurations for successive interference cancellation in accordance with one or more aspects of the present disclosure. In some examples, the wireless communications system 200 may implement aspects of the wireless communications system 100. For example, the wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115 and a network entity 105, it is understood that the described techniques may be performed by a wireless device different from a UE 115 and a network entity 105. As described herein, operations performed by the UE 115-a and the network entity 105-a may be respectively performed by a UE 115, a network entity 105, or another wireless device, and the examples shown should not be construed as limiting.

A transmitting wireless device (e.g., the UE 115-a or the network entity 105-a) may communicate one or more code words using a MIMO structure such that the code words are mapped to multiple spatial layers (e.g., communicated using respective antenna elements of the wireless device). For instance, in some wireless communications systems (e.g., LTE), different code words may be mapped to different respective layers. For example, a wireless device operating in an LTE system may transmit multiple code blocks of a code word using a single spatial layer over multiple time-frequency resources (e.g., resource blocks or resource elements), which may be referred to as a dual code word MIMO design structure or a horizontal mapping. In an example dual code word MIMO design structure, a first code word may be partitioned into three code blocks that may each be transmitted in a different time-frequency resource associated with a first spatial layer 220 and a second code word may be partitioned into three code blocks that may each be transmitted in a different time-frequency resource associated with a second spatial layer 220. The transmitting wireless device may assign different rates to the first code word and the second code word and may apply a hard successive interference cancellation scheme (e.g., based on accurate per-code word channel quality information (CQI)).

In some other wireless systems (e.g., a 5G new radio (NR) system), a single code word may be mapped to multiple layers, in what may be referred to as a single code word MIMO design structure or a vertical mapping (e.g., with irregular low-density parity check (LDPC)). In an example single code word MIMO design structure, a wireless device operating in an NR system may transmit multiple code blocks of a single code word over multiple radio-frequency resources, in some cases using multiple spatial layers in a single time-frequency resource to transmit a same code block or repetitions of a code block. For example, a first code word may be partitioned into a first code block, a second code block, and a third code block. The wireless device may transmit the first code block in a first time-frequency resource using a first spatial layer 220 and a second spatial layer 220; may transmit the second code block in a second time-frequency resource using the first and second spatial layers 220; and may transmit the third code block in a third time-frequency resource using the first and second spatial layers 220. A receiving device may iteratively demodulate and decode the code word across two layers to improve performance. In some cases, LDPC may not be suitable for iterative demodulation and decoding in NR.

However, such techniques may incur significant signaling overhead (e.g., due to per-layer feedback signaling in an LTE system) or may reduce a receiver's ability to properly decode the code word (e.g., due to nonlinear demodulation across multiple layers in an NR system). To overcome such issues, a wireless communications system may implement a single code word design with spatial coupling (e.g., Diagonal Bell Laboratories Space-Time (D-BLAST) type). In a single code word spatially coupled MIMO structure, the transmitting device may select a rate to match a collective channel quality across multiple layers. In a code structure similar to D-BLAST, a single code word may capture more channel realizations. For example, a single code word may be partitioned into a first code block and a second code block. The transmitting device may transmit the first code block of the single code word in a first time-frequency resource using a first spatial layer 220 and may transmit the second code block of the single code word in a second time-frequency resource using a second spatial layer 220 (e.g., a diagonal mapping).

The receiving device may use successive interference cancellation (SIC) to demap and decode code words received from the transmitting device in a spatially coupled MIMO structure. SIC is a technique that may allow the receiving device to decode two or more packets that arrive simultaneously by decoding a first signal (e.g., a first code word or a first packet), subtracting the decoded first signal from the combined signal, and decoding the difference as the second signal. For example, for a spatially coupled MIMO structure that is diagonally mapped, the receiving device (e.g., the UE 115-a or the network entity 105-a) may first demodulate and decode a first code block, subtract the decoded first code block from the received signal, and then successively demodulate and decode a second code block. In the case of successful decoding, the receiver may subtract the decoded second code block from the received signal and repeat this process until each code block in the received signal is successfully decoded or until the receiver declares a code block decoding failure. The SIC decoding enabled by the diagonally-mapped, spatially coupled MIMO structure may allow the receiving device to use a relatively simple demodulator or demapper compared to non-spatially coupled techniques.

However, while diagonal mapping techniques for spatially coupled MIMO with successive interference cancellation may reduce overhead and improve decoding performance compared to simpler MIMO design structures, additional techniques for a relatively large quantity of layers (e.g., more than two layers), for more than one code word, or for both may be desired. For example, a simple diagonal mapping of four layers may introduce implementation complexity or other issues, for example, when a first channel quality associated with a first set of time-frequency resources differs from a fourth quality channel associated with a fourth set of time-frequency resources. To transmit code blocks across three or more spatial layers 220, the transmitter may group layers into layer blocks and perform diagonal mapping on the block level in accordance with a block decomposition configuration 210, which may work for any nontrivial quantity of layers (e.g., three spatial layers 220, four spatial layers 220, or more than four spatial layers 220). Diagonal mapping may create a layer imbalance that devices in the wireless communications system 200 may leverage in determining a block decomposition configuration 210.

In some implementations, the transmitting device may be the UE 115-a and the receiving device may be the network entity 105-a. In such implementations, the UE 115-a may transmit a CSI report 205 to the network entity 105-a. For a given quantity of layers (e.g., X), the network entity 105-a may have two or more block decomposition configuration options. The network entity 105-a may select a block decomposition configuration 210 (e.g., a block decomposition configuration 210 that diagonally maps code block parts on the layer blocks level) for the transmission of code blocks 215 based on the CSI report 205. The network entity 105-a may output, and the UE 115-a may receive, an indication of the block decomposition configuration 210 (e.g., via a DCI message, via a MAC-CE, via an RRC message, or via another type of message). The UE 115-a may transmit multiple code blocks 215 in accordance with the block decomposition configuration 210. The network entity 105-a may obtain the code blocks 215 and may successively decode a first set of time-frequency resources 225-a and a second set of time-frequency resources 225-b in accordance with the block decomposition configuration 210.

In some other implementations, the transmitting device may be the network entity 105-a and the receiving device may be the UE 115-a. In such implementations, the network entity 105-a may select a block decomposition configuration 210 (e.g., based on the CSI report 205) and output the code blocks 215 in accordance with the selected block decomposition configuration 210. The UE 115-a may receive the code blocks 215 and may successively decode a first set of time-frequency resources 225-a and a second set of time-frequency resources 225-b in accordance with the block decomposition configuration 210.

In some examples, the UE 115-a may transmit, to the network entity 105-a, an indication of a requested block decomposition configuration 210 via the CSI report 205, and the network entity 105-a may select a block decomposition configuration 210 based on the indication. In other words, the UE 115-a may feedback a preferred block decomposition configuration 210 to the network entity 105-a through CSI feedback (e.g., together with or as part of the CSI report 205). The requested (e.g., preferred) block decomposition configuration 210 may be associated with a reported rank in the CSI report 205. In some examples, the UE 115-a may report the requested block decomposition configuration 210 for the reported rank instead of reporting the block decomposition configuration for each rank. In some cases, the network entity 105-a may select a block decomposition configuration 210 from a table that indicates all possible block decomposition configurations 210 for each rank (e.g., a table in standards or a table indicated by the UE 115-a). In some cases, the UE 115-a may indicate, to the network entity 105-a, which entries in the table are supported by the UE 115-a. In some examples, the UE 115-a may transmit an indication of a threshold throughput supported by the UE 115-a, a threshold bandwidth supported by the UE 115-a, or both for one or more block decomposition configurations 210 (e.g., via the CSI report 205). The network entity 105-a may select the block decomposition configuration 210 for transmission of the code blocks 215 based on the received indication. That is, the UE 115-a may report different maximum supported throughputs, maximum supported bandwidths, or other maximum supported parameters for different block decomposition configurations 210.

Each block decomposition configuration 210 may be for transmission of two or more code blocks 215 associated with a code word (e.g., a first code word CW0). Each code block may be divided into two or more code block parts, and each code block part may be associated with a respective spatial layer 220. For example, a first code block part CB0 may be associated with a first spatial layer 220, layer 0. The block decomposition configuration 210 may indicate a first quantity of code block parts (e.g., a first layer block, or a first code block group) of a code block to be transmitted via a first set of time-frequency resources 225-a and a second quantity of code block parts (e.g., a second layer block, or a second code block group) of the code block to be transmitted via a second set of time-frequency resources 225-b. In examples where the block decomposition configuration 210 divides the code block parts into two layer blocks, the first quantity of code block parts of the first layer block and the second quantity of code block parts of the second layer may add up to the total quantity of layers. In examples where the block decomposition configuration 210 divides the code block parts into more than two layer blocks, the quantity of code block parts across the multiple layer blocks may add up to the total quantity of layers.

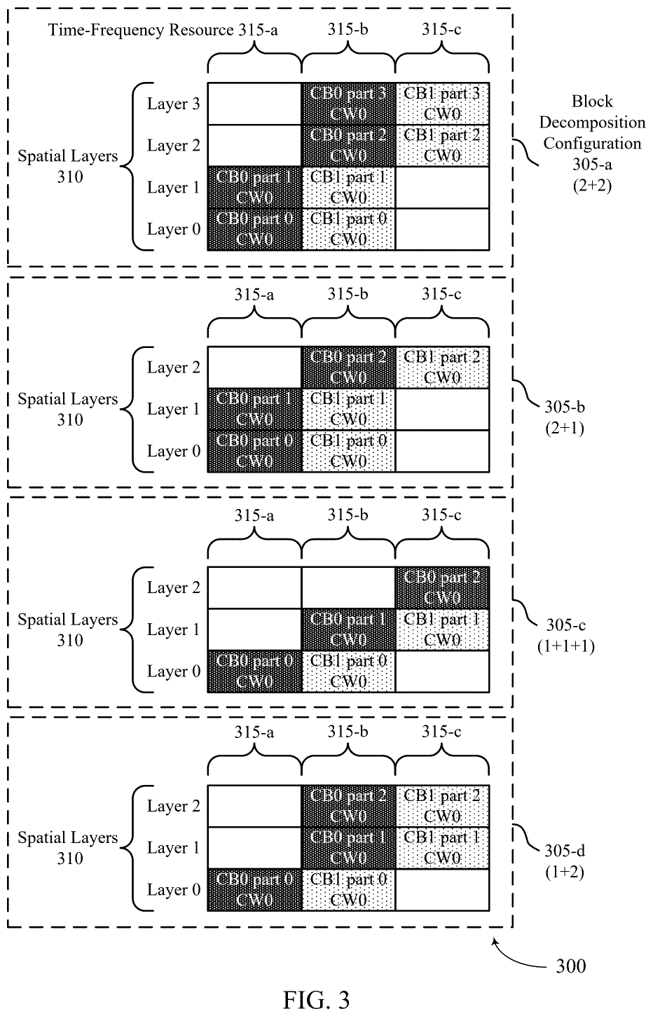

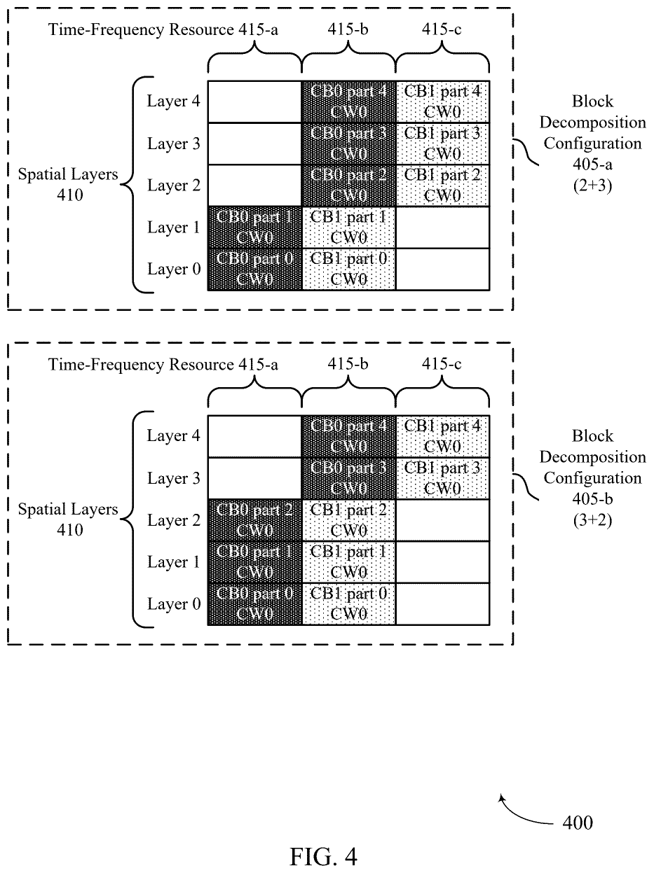

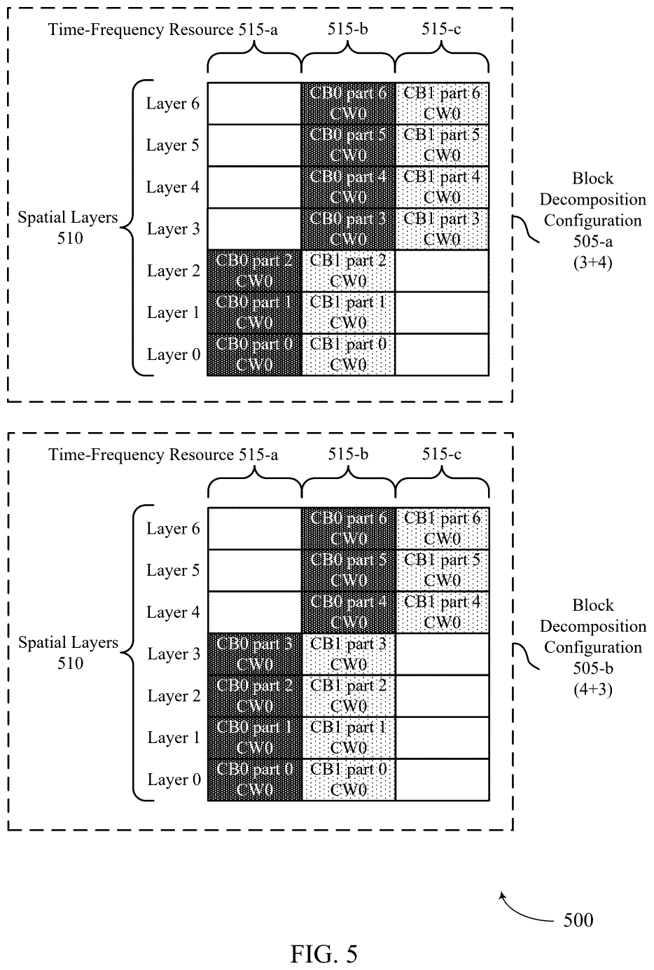

In some examples, the block decomposition configuration 210 may be represented by X=X₀+ . . . +Xₙ, where X represents the total quantity of layers, X₀ represents the first quantity of code block parts (e.g., that are each associated with a spatial layer 220) associated with the first layer block and a first set of time-frequency resources, and Xₙ represents a last quantity of code block parts associated with a last layer block and a last set of time-frequency resources. That is, X total spatial layers 220 may be decomposed as a sum of integers, where each integer in the sum represents a quantity of layers used to transmit code block parts in a set of time-frequency resources. For example, for 4 layers, the network entity 105-a may select a 2+2 block structure for the block decomposition configuration 210, as illustrated by the block decomposition configuration 305-a described in more detail with reference to FIG. 3. FIG. 3 also illustrated the 2+1, 1+1+1, and 1+2 block structures for 3 total spatial layers 220. FIG. 4 illustrates two example block decomposition configurations 210 for 5 total spatial layers 220 (e.g., 2+3 and 3+2), and FIG. 5 illustrates two example block decomposition configurations 210 for 7 total spatial layers 220 (e.g., 3+4 and 4+3). Note that the examples shown in FIGS. 2-5 are examples and should not be construed as limiting. Other combinations for a total quantity of spatial layers X may not be precluded. For example, for 5 total spatial layers 220 (e.g., X=5), a block decomposition configuration 210 may include 1+4, 4+1, 1+2+2, 2+2+1, or any combination of layer blocks that adds up to 5 total spatial layers 220, including a trivial decomposition 5+0. The layer mapping in some wireless communications systems (e.g., NR systems) may be represented by the trivial decomposition X=X+0.

The network entity 105-a may select the block decomposition configuration 210 for transmission of the code blocks 215 based on one or more factors, including interference level associated with one or more spatial layers 220, a threshold throughput (e.g., a maximum supported throughput such as 20 gigabits per second (Gbps)), a latency associated with the block decomposition configuration 210, other factors, or a combination thereof. For example, the UE 115-a may support the 4+0 and the 2+2 block decomposition configurations 210. Relatively low-interference spatial layers 220 may be easier to process, so the network entity 105-a may select the 2+2 block decomposition configuration 210 because the 2+2 decomposition may take fewer cycles and may be processed more quickly. Consequently, a threshold throughput (e.g., a maximum throughput of 20 Gbps) for the 2+2 block decomposition configuration 210 may be higher than a threshold throughput for the 4+0 block decomposition configuration 210 (e.g., 10 Gbps). Similarly, a 3+1 block decomposition configuration 210 may be associated with a relatively moderate latency and may support a relatively moderate threshold throughput (e.g., 15 Gbps). Additionally, or alternatively, the receiving device may use a simpler demodulator (e.g., an MMSE demodulator) for relatively low-interference spatial layers 220 and reserve more complex demodulators (e.g., a PSRD demodulator) for relatively high-interference spatial layers 220 (e.g., using different demodulators for different code block parts of a code word that are mapped to different spatial layers 220). For example, a receiving device may demodulate a first set of time-frequency resources 225-a using an MMSE demodulator and may demodulate a second set of time-frequency resources 225-b using a PSRD demodulator. The 2+1 block decomposition configuration 210 may result in relatively faster processing than the 1+2 block decomposition configuration 210 because 2 layers are demodulated using the simpler MMSE demodulator and 1 layer is demodulated using the more complex PSRD demodulator, compared to 1 layer demodulated using the simpler MMSE demodulator and 2 layers demodulated using the more complex PSRD as in the 1+2 block decomposition configuration 210. However, a channel quality associated with the first set of time-frequency resources 225-a may be lower in the 2+1 block decomposition configuration 210 compared to a channel quality associated with the first set of time-frequency resources in the 1+2 block decomposition configuration 210, because 2 spatial layers 220 are occupied rather than 1 spatial layer 220, potentially causing interference. The network entity 105-a may select a block decomposition configuration 210 based on a priority associated with throughput, MCS size, hardware limitations, channel quality, processing time, or other factors (e.g., factors included in the CSI report 205). Hence, it may be beneficial for the UE 115-a to modify the contents of the CSI report 205 based on the block decomposition configuration 210.

For 2 total spatial layers 220, the network entity 105-a may select from two decomposition options: a first decomposition X=2+0 (e.g., decomposition 0, the trivial decomposition, or the NR mapping) and a second decomposition X=1+1 (e.g., decomposition 1, a non-trivial decomposition). In some examples, the network entity 105-a may select the first decomposition or the second decomposition for the transmission of the code blocks 215 (e.g., transmission by the network entity 105-a or by the UE 115-a) to dynamically or semi-statically switch between spatially coupled MIMO and non-spatially coupled MIMO.

In some examples, a single code word may occupy the available spatial layers 220. Additionally, or alternatively, the network entity 105-a may schedule two or more code words when the total quantity of spatial layers 220 exceeds a threshold value (e.g., more than four total layers). In this case, the network entity 105-a may indicate a block decomposition configuration 210 for each code word (e.g., a first block decomposition configuration 210 for a first code word and a second block decomposition configuration 210 for a second code word). In some cases where two code words have a same total quantity of spatial layers 220, the block decomposition configuration 210 may be the same for the first code word and the second code word (e.g., when the total quantity of spatial layers 220 may be even, such as 6 layers or 8 layers). In some other cases, a first block decomposition configuration 210 for the first code word may be different from a second block decomposition configuration 210 for the second code word. In such cases, the network entity 105-a may signal (e.g., indicate) the first block decomposition configuration 210 and the second block decomposition configuration 210 separately (e.g., signal a block decomposition configuration 210 for each code word separately). In some examples, devices in the wireless communications system 200 may use spatially coupled MIMO on the first code word (e.g., on a first subset of spatial layers 220) and may use non-spatially coupled MIMO on the second code word (e.g., on a second subset of spatial layers 220).

FIG. 3 shows an example of a resource diagram 300 that supports block decomposition configurations for successive interference cancellation in accordance with one or more aspects of the present disclosure. The resource diagram 300 may implement or be implemented by one or more aspects of the wireless communications system 100 and the wireless communications system 200 described with reference to FIGS. 1 and 2, respectively. For example, the resource diagram 300 may be implemented by a network entity 105 and a UE 115 as described with reference to FIGS. 1 and 2 to support successive interference cancellation.

For example, the resource diagram 300 may be utilized during an example transmission from the UE 115-a to the network entity 105-a, or from the network entity 105-a to the UE 115-a, as described with reference to FIG. 2. The UE 115 may transmit, to the network entity 105, a CSI report. The network entity 105 may select a block decomposition configuration 305 from a set of multiple block decomposition configurations 305 based on the CSI report. If the UE 115 is the transmitter, the network entity 105 may transmit, to the UE 115, an indication of the selected block decomposition configuration 305 and the UE 115 may transmit two or more code blocks of one or more code words to the network entity 105 in accordance with the indicated block decomposition configuration 305. If the network entity 105 is the transmitter, the network entity 105 may transmit two or more code blocks of one or more code words to the UE 115 in accordance with the selected block decomposition configuration 305.

The resource diagram 300 includes a block decomposition configuration 305-a with four spatial layers 310 (e.g., layer 0, layer 1, layer 2, and layer 3) and three sets of time-frequency resources 315-a, 315-b, and 315-c. A first code word CW0 is split into two code blocks, CB0 and CB1, and each code block is divided into four code block parts (part 0, part 1, part 2, and part 3). The block decomposition configuration 305-a indicates a 2+2 block structure, such that two code block parts of the first code block of the first code word (CB0 part 0 CW0 and CB0 part 1 CB0) are transmitted in the first set of time-frequency resources 315-a via layer 0 and layer 1, respectively, and the remaining two code block parts of the first code block of the first code word (e.g., CB0 part 2 CW0 and CB0 part 3 CW0) are transmitted in the second set of time-frequency resources 315-b via layer 2 and layer 3, respectively. Similarly, for the second code block CB1, two code block parts of the second code block of the first code word (CB 1 part 0 CW0 and CB1 part 1 CB0) are transmitted in the second set of time-frequency resources 315-b via layer 0 and layer 1, respectively, and the remaining two code block parts of the second code block of the first code word (e.g., CB1 part 2 CW0 and CB 1 part 3 CW0) are transmitted in the third set of time-frequency resources 315-c via layer 2 and layer 3, respectively.

The remaining block decomposition configurations 305 of the resource diagram 300 (e.g., the block decomposition configuration 305-b, the block decomposition configuration 305-c, and the block decomposition configuration 305-d) show the three non-trivial decompositions for three layers. For example, the block decomposition configuration 305-b illustrates a 2+1 block structure, such that the first two code block parts of the first code block of the first code word (e.g., CB0 part 0 CW0 and CB0 part 1 CW0) are transmitted in the first set of time-frequency resources 315-a via layer 0 and layer 1, respectively, and the remaining one code block part of the first code block of the first code word (e.g., CB0 part 2 CW0) is transmitted in the second set of time-frequency resources 315-b via layer 2. Similarly, for the second code block, the first two code block parts of the second code block of the first code word (e.g., CB1 part 0 CW0 and CB1 part 1 CW0) are transmitted in the second set of time-frequency resources 315-b via layer 0 and layer 1, respectively, and the remaining one code block part of the second code block of the first code word (e.g., CB1 part 2 CW0) is transmitted in the third set of time-frequency resources 315-c via layer 2.

The block decomposition configuration 305-c illustrates a 1+1+1 block structure (e.g., a diagonal mapping), such that the first code block part of the first code block of the first code word (e.g., CB0 part 0 CW0) is transmitted in the first set of time-frequency resources 315-a via layer 0, the second code block part of the first code block of the first code word (e.g., CB0 part 1 CW0) is transmitted in the second set of time-frequency resources 315-b via layer 1, and the third code block part of the first code block of the first code word (e.g., CB0 part 2 CW0) is transmitted in the third set of time-frequency resources 315-c via layer 2. Similarly, for the second code block, the first code block part of the second code block of the first code word (e.g., CB1 part 0 CW0) is transmitted in the second set of time-frequency resources 315-b, the second code block part of the second code block of the first code word (e.g., CB1 part 1 CW0) is transmitted in the third set of time-frequency resources 315-c, and the third code block part of the second code block of the first code word (e.g., CB1 part 2 CW0) is transmitted in a fourth set of time-frequency resources (e.g., not pictured).

The block decomposition configuration 305-d illustrates a 1+2 block structure, such that the first code block part of the first code block of the first code word (e.g., CB0 part 0 CW0) is transmitted in the first set of time-frequency resources 315-a via layer 0, and the remaining two code block parts of the first code block of the first code word (e.g., CB0 part 1 CW0 and CB0 part 2 CW0) are transmitted in the second set of time-frequency resources 315-b via layer 1 and layer 2, respectively. Similarly, for the second code block, the first code block part of the second code block of the first code word (e.g., CB1 part 0 CW0) is transmitted in the second set of time-frequency resources 315-b via layer 0 and the remaining two code block parts of the second code block of the first code word (e.g., CB1 part 1 CW0 and CB1 part 2 CW0) are transmitted in the third set of time-frequency resources 315-c via layer 1 and layer 2, respectively.

In some examples, for 3 layers, the network entity 105 may select one of the block decomposition configuration 305-a, the block decomposition configuration 305-b, and the block decomposition configuration 305-c based on a CSI report. The CSI report may indicate one of the block decomposition configuration 305-a, the block decomposition configuration 305-b, and the block decomposition configuration 305-c as a requested (e.g., preferred) configuration.

The network entity 105 may select a block decomposition configuration 305 based on one or more factors. For example, the receiving device (e.g., the network entity 105 or the UE 115) may use a simpler demodulator (e.g., an MMSE demodulator) for relatively low-interference spatial layers 310 and reserve more complex demodulators (e.g., a PSRD demodulator) for relatively high-interference spatial layers 310 (e.g., using different demodulators for different code block parts of a code word that are mapped to different spatial layers 310). For example, a receiving device may demodulate a first set of time-frequency resources 315-a using an MMSE demodulator and may demodulate a second set of time-frequency resources 315-b using a PSRD demodulator. The 2+1 block decomposition configuration 305-b may result in relatively faster processing than the 1+2 block decomposition configuration 305-d because 2 layers are demodulated using the simpler MMSE demodulator and 1 layer is demodulated using the more complex PSRD demodulator in the first set of time-frequency resources 315-a, compared to 1 layer demodulated using the simpler MMSE demodulator and 2 layers demodulated using the more complex PSRD as in the 1+2 block decomposition configuration 305-d. However, a channel quality associated with the first set of time-frequency resources 315-a may be lower in the 2+1 block decomposition configuration 305-b compared to a channel quality associated with the first set of time-frequency resources 315-a in the 1+2 block decomposition configuration 305-d, because 2 spatial layers 310 are occupied rather than 1 spatial layer 310, potentially causing interference. The 1+1+1 block decomposition configuration 305-c may be a moderate option, with moderate channel quality and moderate demodulator simplicity compared to the block decomposition configuration 305-b and the block decomposition configuration 305-d. The network entity 105 may select a block decomposition configuration 305 based on a priority associated with throughput, MCS size, hardware limitations, channel quality, processing time, or other factors (e.g., factors included in the CSI report). Hence, it may be beneficial for the UE 115 to modify the contents of the CSI report based on the block decomposition configurations 305.

While only one block decomposition configuration with four layers (e.g., the block decomposition configuration 305-a with a 2+2 block structure) and three block decomposition configurations with three layers (e.g., the block decomposition configuration 305-b with a 2+1 block structure, the block decomposition configuration 305-c with a 1+1+1 block structure, and the block decomposition configuration 305-d with a 1+2 block structure) are depicted in the resource diagram 300, other decompositions of four layers (e.g., 1+3, 3+1, the trivial decomposition 4+0, etc.) and three layers (e.g., the trivial decomposition 3+0) are possible. Similarly, while the examples shown in the resource diagram 300 depict a single code word divided into two code blocks (e.g., CB0 and CB1 of CW0), there may be other examples with more than one code word (e.g., as described with reference to FIG. 2) and there may be examples where each code word is divided into more than two code blocks (e.g., CB0, CB1, CB2, etc.). The examples shown here should not be construed as limiting.

FIG. 4 shows an example of a resource diagram 400 that supports block decomposition configurations for successive interference cancellation in accordance with one or more aspects of the present disclosure. The resource diagram 400 may implement or be implemented by one or more aspects of the wireless communications system 100 and the wireless communications system 200 described with reference to FIGS. 1 and 2, respectively. For example, the resource diagram 400 may be implemented by a network entity 105 and a UE 115 as described with reference to FIGS. 1 and 2 to support successive interference cancellation.

For example, the resource diagram 400 may be utilized during an example transmission from the UE 115-a to the network entity 105-a, or from the network entity 105-a to the UE 115-a, as described with reference to FIG. 2. The UE 115 may transmit, to the network entity 105, a CSI report. The network entity 105 may select a block decomposition configuration 405 from a set of multiple block decomposition configurations 405 based on the CSI report. If the UE 115 is the transmitter, the network entity 105 may transmit, to the UE 115, an indication of the selected block decomposition configuration 405 and the UE 115 may transmit two or more code blocks of one or more code words to the network entity 105 in accordance with the indicated block decomposition configuration 405. If the network entity 105 is the transmitter, the network entity 105 may transmit two or more code blocks of one or more code words to the UE 115 in accordance with the selected block decomposition configuration 405.

The resource diagram 400 includes the block decomposition configuration 405-a and the block decomposition configuration 405-b, each with five spatial layers 410 (e.g., layer 0, layer 1, layer 2, layer 3, and layer 4) and three sets of time-frequency resources 415-a, 415-b, and 415-c. A first code word CW0 is split into two code blocks, CB0 and CB1, and each code block is divided into five code block parts (part 0, part 1, part 2, part 3, and part 4). The block decomposition configuration 405-a indicates a 2+3 block structure, such that two code block parts of the first code block of the first code word (CB0 part 0 CW0 and CB0 part 1 CB0) are transmitted in the first set of time-frequency resources 415-a via layer 0 and layer 1, respectively, and the remaining three code block parts of the first code block of the first code word (e.g., CB0 part 2 CW0, CB0 part 3 CW0, and CB0 part 4 CW0) are transmitted in the second set of time-frequency resources 415-b via layer 2, layer 3, and layer 4, respectively. Similarly, for the second code block CB1, two code block parts of the second code block of the first code word (CB 1 part 0 CW0 and CB1 part 1 CB0) are transmitted in the second set of time-frequency resources 415-b via layer 0 and layer 1, respectively, and the remaining three code block parts of the second code block of the first code word (e.g., CB1 part 2 CW0, CB1 part 3 CW0, and CB1 part 4 CW0) are transmitted in the third set of time-frequency resources 415-c via layer 2, layer 3, and layer 4, respectively.

The block decomposition configuration 405-b indicates a 3+2 block structure, such that three code block parts of the first code block of the first code word (CB0 part 0 CW0, CB0 part 1 CB0, and CB0 part 2 CW0) are transmitted in the first set of time-frequency resources 415-a via layer 0, layer 1, and layer 2, respectively, and the remaining two code block parts of the first code block of the first code word (e.g., CB0 part 3 CW0 and CB0 part 4 CW0) are transmitted in the second set of time-frequency resources 415-b via layer 3 and layer 4, respectively. Similarly, for the second code block CB1, three code block parts of the second code block of the first code word (CB1 part 0 CW0, CB 1 part 1 CB0, and CB1 part 2 CW0) are transmitted in the second set of time-frequency resources 415-b via layer 0, layer 1, and layer 2, respectively, and the remaining two code block parts of the second code block of the first code word (e.g., CB1 part 3 CW0 and CB1 part 4 CW0) are transmitted in the third set of time-frequency resources 415-c via layer 3 and layer 4, respectively.

While only two block decomposition configurations with five layers are depicted in the resource diagram 400 (e.g., the block decomposition configuration 405-a with a 2+3 block structure and the block decomposition configuration 405-b with a 3+2 block structure), other decompositions of five layers are possible (e.g., 1+4, 4+1, 1+2+2, 3+1+1, the trivial decomposition 5+0, etc.). Similarly, while the examples shown in the resource diagram 400 depict a single code word divided into two code blocks (e.g., CB0 and CB1 of CW0), there may be other examples with more than one code word (e.g., as described with reference to FIG. 2) and there may be examples where each code word is divided into more than two code blocks (e.g., CB0, CB1, CB2, etc.). The examples shown here should not be construed as limiting.

FIG. 5 shows an example of a resource diagram 500 that supports block decomposition configurations for successive interference cancellation in accordance with one or more aspects of the present disclosure. The resource diagram 500 may implement or be implemented by one or more aspects of the wireless communications system 100 and the wireless communications system 200 described with reference to FIGS. 1 and 2, respectively. For example, the resource diagram 500 may be implemented by a network entity 105 and a UE 115 as described with reference to FIGS. 1 and 2 to support successive interference cancellation.

For example, the resource diagram 500 may be utilized during an example transmission from the UE 115-a to the network entity 105-a, or from the network entity 105-a to the UE 115-a, as described with reference to FIG. 2, or another network entity 105 and UE 115. The UE 115 may transmit, to the network entity 105, a CSI report. The network entity 105 may select a block decomposition configuration 505 from a set of multiple block decomposition configurations 505 based on the CSI report. If the UE 115 is the transmitter, the network entity 105 may transmit, to the UE 115, an indication of the selected block decomposition configuration 505 and the UE 115 may transmit two or more code blocks of one or more code words to the network entity 105 in accordance with the indicated block decomposition configuration 505. If the network entity 105 is the transmitter, the network entity 105 may transmit two or more code blocks of one or more code words to the UE 115 in accordance with the selected block decomposition configuration 505.

The resource diagram 500 includes the block decomposition configuration 505-a and the block decomposition configuration 505-b, each with seven spatial layers 510 (e.g., layer 0, layer 1, layer 2, layer 3, layer 4, layer 5, and layer 6) and three sets of time-frequency resources 515-a, 515-b, and 515-c. A first code word CW0 is split into two code blocks, CB0 and CB1, and each code block is divided into seven code block parts (part 0, part 1, part 2, part 3, part 4, part 5, and part 6, corresponding to the seven spatial layers 510). The block decomposition configuration 505-a indicates a 3+4 block structure, such that three code block parts of the first code block of the first code word (CB0 part 0 CW0, CB0 part 1 CB0, CB0 part 2 CW0) are transmitted in the first set of time-frequency resources 515-a via layer 0, layer 1, and layer 2, respectively, and the remaining four code block parts of the first code block of the first code word (e.g., CB0 part 3 CW0, CB0 part 4 CW0, CB0 part 5 CW0, and CB0 part 6 CW0) are transmitted in the second set of time-frequency resources 515-b via layer 3, layer 4, layer 5, and layer 6, respectively. Similarly, for the second code block CB1, three code block parts of the second code block of the first code word (CB 1 part 0 CW0, CB1 part 1 CB0, and CB1 part 2 CW0) are transmitted in the second set of time-frequency resources 515-b via layer 0, layer 1, and layer 2, respectively, and the remaining four code block parts of the second code block of the first code word (e.g., CB1 part 3 CW0, CB1 part 4 CW0, CB1 part 5 CW0, and CB1 part 6 CW0) are transmitted in the third set of time-frequency resources 515-c via layer 3, layer 4, layer 5, and layer 6, respectively.

The block decomposition configuration 505-b indicates a 4+3 block structure, such that four code block parts of the first code block of the first code word (CB0 part 0 CW0, CB0 part 1 CB0, CB0 part 2 CW0, and CB0 part 3 CW0) are transmitted in the first set of time-frequency resources 515-a via layer 0, layer 1, layer 2, and layer 3, respectively, and the remaining three code block parts of the first code block of the first code word (e.g., CB0 part 4 CW0, CB0 part 5 CW0, and CB0 part 6 CW0) are transmitted in the second set of time-frequency resources 515-b via layer 4, layer 5, and layer 6, respectively. Similarly, for the second code block CB1, four code block parts of the second code block of the first code word (CB1 part 0 CW0, CB1 part 1 CB0, CB1 part 2 CW0, and CB1 part 3 CW0) are transmitted in the second set of time-frequency resources 515-b via layer 0, layer 1, layer 2, and layer 3, respectively, and the remaining three code block parts of the second code block of the first code word (e.g., CB1 part 4 CW0, CB1 part 5 CW0, and CB1 part 6 CW0) are transmitted in the third set of time-frequency resources 515-c via layer 4, layer 5, and layer 6, respectively.

While only two block decomposition configurations with seven layers are depicted in the resource diagram 500 (e.g., the block decomposition configuration 505-a with a 3+4 block structure and the block decomposition configuration 505-b with a 4+3 block structure), other decompositions of seven layers are possible (e.g., 2+5, 5+2, 2+3+2, the trivial decomposition 7+0, etc.). Similarly, while the examples shown in the resource diagram 500 depict a single code word divided into two code blocks (e.g., CB0 and CB1 of CW0), there may be other examples with more than one code word (e.g., as described with reference to FIG. 2) and there may be examples where each code word is divided into more than two code blocks (e.g., CB0, CB1, CB2, etc.). The examples shown here should not be construed as limiting.

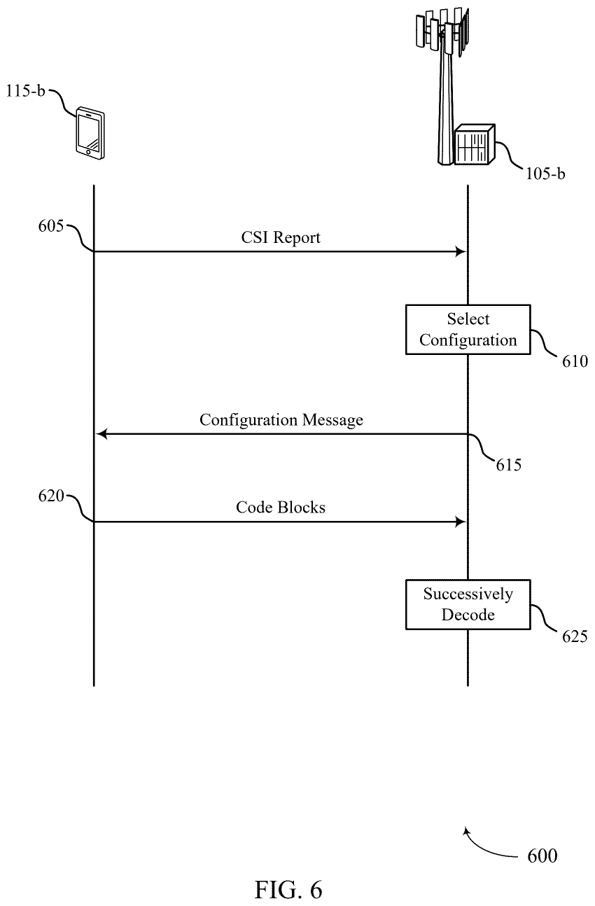

FIG. 6 shows an example of a process flow 600 that supports block decomposition configurations for successive interference cancellation in accordance with one or more aspects of the present disclosure. In some examples, the process flow 600 may be implemented by, or may implement aspects of, the wireless communications systems 100 and 200 and the resource diagrams 300, 400, and 500. For example, the process flow 600 includes a network entity 105-b (e.g., a receiving device or obtaining device) and a UE 115-b (e.g., a transmitting device), which may be examples of the corresponding devices described with reference to FIGS. 1 and 2. Following the process flow 600, the network entity 105-b may successively decode a quantity of code blocks in accordance with a block decomposition configuration. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 600, some aspects of some operations may also be performed by one or more other wireless devices.

At 605, the UE 115-b may transmit, and the network entity 105-b may obtain, a CSI report (e.g., the CSI report 205 described with reference to FIG. 2). In some examples, the CSI report may include an indication of a requested block decomposition configuration (e.g., a preferred configuration). The requested block decomposition configuration may be based on a reported rank in the CSI report. In some examples, the CSI report may include an indication of a threshold throughput (e.g., a maximum throughput) supported by the UE 115-b, a threshold bandwidth (e.g., a maximum bandwidth) supported by the UE 115-b, or both for one or more of a set of multiple block decomposition configurations. For example, the CSI report may indicate a first threshold throughput, a first threshold bandwidth, or both for a first block decomposition configuration and may indicate a second threshold throughput, a second threshold bandwidth, or both for a second block decomposition configuration.

At 610, the network entity 105-b may select a block decomposition configuration for transmission of a set of multiple code blocks associated with at least one code word. Each code block of the set of multiple code blocks may be divided into multiple code block parts, and each code block part may be associated with a respective spatial layer. The block decomposition configuration may indicate a first quantity of code block parts of a code block to be output via a first set of time-frequency resources and may indicate a second quantity of code block parts of the code block to be output via a second set of time-frequency resources. In some examples, the network entity 105-b may select the block decomposition configuration based on the CSI report obtained at 605. For example, the selection may be based on the indication of the requested block decomposition configuration, the indication of the threshold throughput, the indication of the threshold bandwidth, or any combination thereof. In some examples, the network entity 105-b may select the block decomposition configuration from a set of multiple block decomposition configurations associated with a quantity of spatial layers. For example, there may a first set of block decomposition configuration options associated with 3 layers (e.g., 1+2, 1+1+1, 2+1, the trivial block decomposition configuration 3+0, or any combination thereof), there may be a second set of block decomposition configuration options associated with four layers, and so on for any quantity of layers. In some cases, the set of multiple block decomposition configurations may include a trivial decomposition (e.g., 4+0 for four layers) in which each of the code block parts of the multiple code blocks may be output via the first set of time-frequency resources.

At 615, the network entity 105-b may output, and the UE 115-b may receive, an indication of the selected block decomposition configuration for transmission of the set of multiple code blocks associated with at least one code word. In some examples, the network entity 105-a may output the indication of the block decomposition configuration via a DCI message, via a MAC-CE, or via an RRC message. In some examples, the network entity 105-b may output, and the UE 115-b may receive, an indication of a first block decomposition configuration for a first code word and an indication of a second block decomposition configuration for a second code word based on a quantity of spatial layers exceeding a threshold (e.g., there are more than four spatial layers). In some cases, the first block decomposition configuration may be the same as the second block decomposition configuration (e.g., based on the quantity of spatial layers being an even number). In some other cases, the first block decomposition configuration may be different from the second block decomposition configuration (e.g., based on the quantity of spatial layers being an odd number). In some cases, the first block decomposition configuration, the second block decomposition configuration, or both may include a trivial decomposition (e.g., the 5+0 decomposition for five spatial layers) in which each of the code block parts of a code block is to be transmitted via the first set of time-frequency resources.

At 620, the UE 115-b may transmit, and the network entity 105-b may obtain, the set of multiple code blocks in accordance with the block decomposition configuration. For example, if the network entity 105-b selected a 1+2 block decomposition configuration for three layers (e.g., the block decomposition configuration 305-d as described with reference to FIG. 3), the UE 115-b may transmit a first code block part of a first code block of a first code word (e.g., CB0 part 0 CW0) in the first set of time-frequency resources via layer 0, and may transmit the remaining two code block parts of the first code block of the first code word (e.g., CB0 part 1 CW0 and CB0 part 2 CW0) in the second set of time-frequency resources via layer 1 and layer 2, respectively. Similarly, for the second code block, the UE 115-b may transmit a first code block part of the second code block of the first code word (e.g., CB1 part 0 CW0) in the second set of time-frequency resources via layer 0 and may transmit the remaining two code block parts of the second code block of the first code word (e.g., CB1 part 1 CW0 and CB1 part 2 CW0) in the third set of time-frequency resources via layer 1 and layer 2, respectively.

At 625, the network entity 105-b may successively decode the first set of time-frequency resources and the second set of time-frequency resources in accordance with the selected block decomposition configuration. For example, the network entity 105-b may decode the first quantity of code block parts associated with the first set of time-frequency resources, subtract the decoded first quantity of code block parts from a signal carrying the multiple code blocks, and decode the second quantity of code block parts associated with the second set of time-frequency resources. In some examples, the network entity 105-b may use a same decoder (e.g., a demapper, demodulator) for the first quantity of code block parts and for the second quantity of code block parts. In some other examples, the network entity 105-b may use a first demodulator (e.g., an MMSE demodulator) for the first quantity of code block parts and a second demodulator (e.g., a PSRD demodulator) for the second quantity of code block parts, where the first demodulator and the second demodulator are different. The successive decoding may extend to more quantities of code block parts associated with more sets of time-frequency resources (e.g., for the 1+1+1 block decomposition configuration). For example, the network entity 105-b may subtract the decoded second quantity of code block parts from the signal carrying the multiple code blocks and may decode a third quantity of code block parts associated with a third set of time-frequency resources in accordance with the block decomposition configuration. The successive decoding may continue until all code block parts of the multiple code blocks of the code word have been decoded.

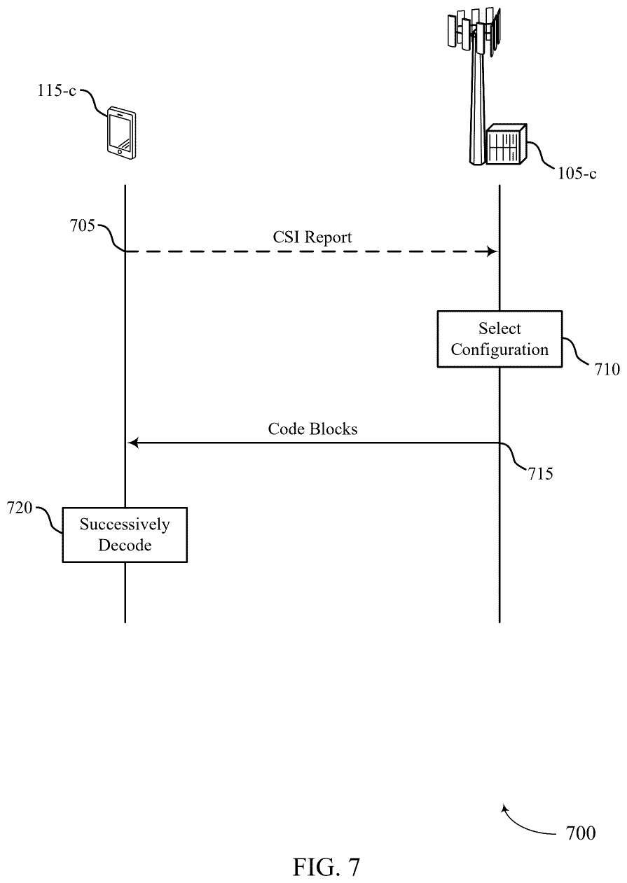

FIG. 7 shows an example of a process flow 700 that supports block decomposition configurations for successive interference cancellation in accordance with one or more aspects of the present disclosure. In some examples, the process flow 700 may be implemented by, or may implement aspects of, the wireless communications systems 100 and 200 and the resource diagrams 300, 400, and 500. For example, the process flow 700 includes a network entity 105-c (e.g., a transmitting device or outputting device) and a UE 115-c (e.g., a receiving device), which may be examples of the corresponding devices described with reference to FIGS. 1 and 2. Following the process flow 700, the UE 115-c may successively decode a quantity of code blocks in accordance with a block decomposition configuration. Alternative examples of the following may be implemented, where some steps are performed in a different order than described or are not performed at all. In some cases, steps may include additional features not mentioned below, or further steps may be added. Although the UE 115-c and the network entity 105-c are shown performing the operations of the process flow 700, some aspects of some operations may also be performed by one or more other wireless devices.

At 705, the UE 115-c may transmit, and the network entity 105-c may obtain, a CSI report (e.g., the CSI report 205 described with reference to FIG. 2). In some examples, the CSI report may include an indication of a requested block decomposition configuration (e.g., a preferred configuration). The requested block decomposition configuration may be based on a reported rank in the CSI report. In some examples, the CSI report may include an indication of a threshold throughput (e.g., a maximum throughput) supported by the UE 115-c, a threshold bandwidth (e.g., a maximum bandwidth) supported by the UE 115-c, or both for one or more of a set of multiple block decomposition configurations. For example, the CSI report may indicate a first threshold throughput, a first threshold bandwidth, or both for a first block decomposition configuration and may indicate a second threshold throughput, a second threshold bandwidth, or both for a second block decomposition configuration.

At 710, the network entity 105-c may select a block decomposition configuration for transmission of multiple code blocks associated with a code word. Each of the multiple code blocks may be divided into multiple code block parts that are each associated with a respective spatial layer. The block decomposition configuration may indicate a first quantity of code block parts of a code block of the multiple code blocks to be output via a first set of time-frequency resources and may indicate at least a second quantity of code block parts of the code block of the multiple code blocks to be output via a second set of time-frequency resources. In some examples, the network entity 105-c may select the block decomposition configuration based on the CSI report obtained at 605. For example, the selection may be based on the indication of the requested block decomposition configuration, the indication of the threshold throughput, the indication of the threshold bandwidth, or any combination thereof. In some examples, the network entity 105-c may select the block decomposition configuration from a set of multiple block decomposition configurations associated with a quantity of spatial layers. For example, there may be three block decomposition configuration options associated with 3 layers. In some cases, the set of multiple block decomposition configurations may include a trivial decomposition (e.g., 4+0 for four layers) in which each of the code block parts of the multiple code blocks may be output via the first set of time-frequency resources. In some examples, the network entity 105-c may output, to the UE 115-c, an indication of the selected block decomposition configuration via a DCI message, via a MAC-CE, or via an RRC message.

In some examples, the network entity 105-c may select a first block decomposition configuration for a first code word and may select a second block decomposition configuration for a second code word based on a quantity of spatial layers exceeding a threshold (e.g., there are more than four spatial layers). In some cases, the first block decomposition configuration may be the same as the second block decomposition configuration (e.g., based on the quantity of spatial layers being an even number). In some other cases, the first block decomposition configuration may be different from the second block decomposition configuration (e.g., based on the quantity of spatial layers being an odd number). In some cases, the first block decomposition configuration, the second block decomposition configuration, or both may include a trivial decomposition (e.g., the 5+0 decomposition for five spatial layers) in which each of the code block parts of a code block is to be transmitted via the first set of time-frequency resources.

At 715, the network entity 105-c may output, and the UE 115-c may receive, the multiple code blocks in accordance with the selected block decomposition configuration. For example, if the network entity 105-c selected a 1+2 block decomposition configuration for three layers (e.g., the block decomposition configuration 305-d as described with reference to FIG. 3), the network entity 105-c may transmit a first code block part of a first code block of a first code word (e.g., CB0 part 0 CW0) in the first set of time-frequency resources via layer 0, and may transmit the remaining two code block parts of the first code block of the first code word (e.g., CB0 part 1 CW0 and CB0 part 2 CW0) in the second set of time-frequency resources via layer 1 and layer 2, respectively. Similarly, for the second code block, the network entity 105-c may transmit a first code block part of the second code block of the first code word (e.g., CB 1 part 0 CW0) in the second set of time-frequency resources via layer 0 and may transmit the remaining two code block parts of the second code block of the first code word (e.g., CB1 part 1 CW0 and CB 1 part 2 CW0) in the third set of time-frequency resources via layer 1 and layer 2, respectively.

At 720, the UE 115-c may successively decode the first set of time-frequency resources and the second set of time-frequency resources in accordance with the selected block decomposition configuration. For example, the UE 115-c may decode the first quantity of code block parts associated with the first set of time-frequency resources, subtract the decoded first quantity of code block parts from a signal carrying the multiple code blocks, and decode the second quantity of code block parts associated with the second set of time-frequency resources. In some examples, the UE 115-c may use a same decoder (e.g., a demapper, demodulator) for the first quantity of code block parts and for the second quantity of code block parts. In some other examples, the UE 115-c may use a first demodulator (e.g., an MMSE demodulator) for the first quantity of code block parts and a second demodulator (e.g., a PSRD demodulator) for the second quantity of code block parts, where the first demodulator and the second demodulator are different. The successive decoding may extend to more quantities of code block parts associated with more sets of time-frequency resources (e.g., for the 1+1+1 block decomposition configuration). For example, the UE 115-c may subtract the decoded second quantity of code block parts from the signal carrying the multiple code blocks and may decode a third quantity of code block parts associated with a third set of time-frequency resources in accordance with the block decomposition configuration. The successive decoding may continue until all code block parts of the multiple code blocks of the code word have been decoded.

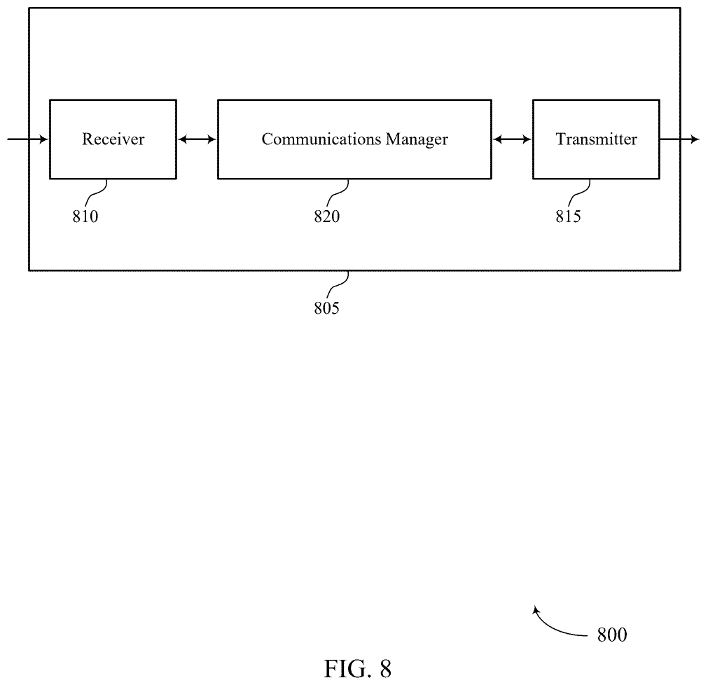

FIG. 8 shows a block diagram 800 of a device 805 that supports block decomposition configurations for successive interference cancellation in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to block decomposition configurations for successive interference cancellation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to block decomposition configurations for successive interference cancellation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of block decomposition configurations for successive interference cancellation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting, to a network entity, a channel state information report. The communications manager 820 is capable of, configured to, or operable to support a means for receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The communications manager 820 is capable of, configured to, or operable to support a means for transmitting the set of multiple code blocks in accordance with the block decomposition configuration.

Additionally, or alternatively, the communications manager 820 may support wireless communications in accordance with examples as disclosed herein. For example, the communications manager 820 is capable of, configured to, or operable to support a means for receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The communications manager 820 is capable of, configured to, or operable to support a means for successively decoding the first set of time-frequency resources and the second set of time-frequency resources in accordance with the block decomposition configuration.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing and more efficient utilization of communication resources.

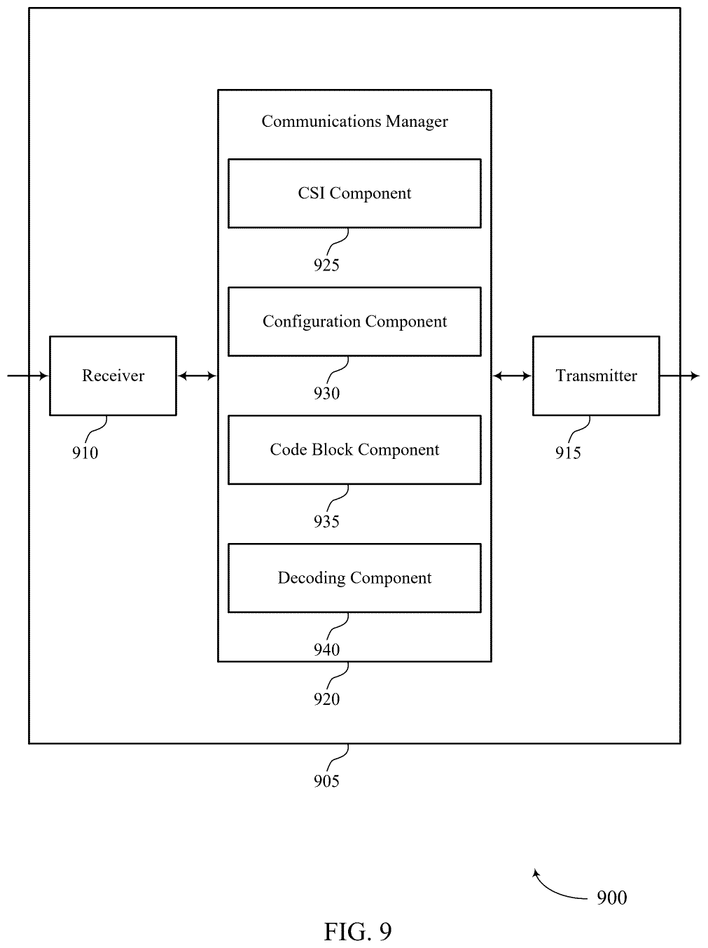

FIG. 9 shows a block diagram 900 of a device 905 that supports block decomposition configurations for successive interference cancellation in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to block decomposition configurations for successive interference cancellation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to block decomposition configurations for successive interference cancellation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of block decomposition configurations for successive interference cancellation as described herein. For example, the communications manager 920 may include a CSI component 925, a configuration component 930, a code block component 935, a decoding component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The CSI component 925 is capable of, configured to, or operable to support a means for transmitting, to a network entity, a channel state information report. The configuration component 930 is capable of, configured to, or operable to support a means for receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The code block component 935 is capable of, configured to, or operable to support a means for transmitting the set of multiple code blocks in accordance with the block decomposition configuration.

Additionally, or alternatively, the communications manager 920 may support wireless communications in accordance with examples as disclosed herein. The code block component 935 is capable of, configured to, or operable to support a means for receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The decoding component 940 is capable of, configured to, or operable to support a means for successively decoding the first set of time-frequency resources and the second set of time-frequency resources in accordance with the block decomposition configuration.

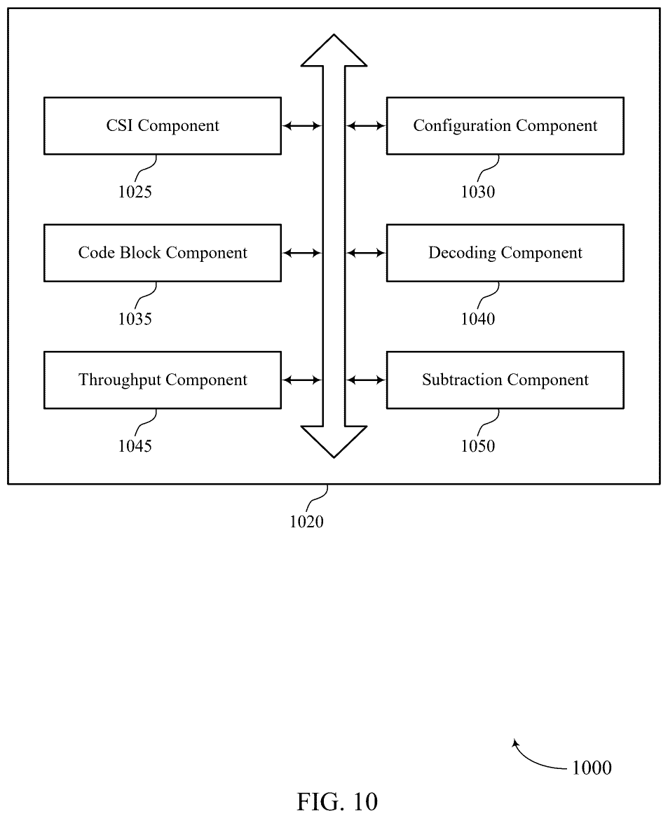

FIG. 10 shows a block diagram 1000 of a communications manager 1020 that supports block decomposition configurations for successive interference cancellation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of block decomposition configurations for successive interference cancellation as described herein. For example, the communications manager 1020 may include a CSI component 1025, a configuration component 1030, a code block component 1035, a decoding component 1040, a throughput component 1045, a subtraction component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The CSI component 1025 is capable of, configured to, or operable to support a means for transmitting, to a network entity, a channel state information report. The configuration component 1030 is capable of, configured to, or operable to support a means for receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The code block component 1035 is capable of, configured to, or operable to support a means for transmitting the set of multiple code blocks in accordance with the block decomposition configuration.

In some examples, to support receiving the indication of the block decomposition configuration, the configuration component 1030 is capable of, configured to, or operable to support a means for receiving the indication of the block decomposition configuration via a DCI message, via a medium access control-control element (MAC-CE), or via an RRC message.

In some examples, to support transmitting the channel state information report, the configuration component 1030 is capable of, configured to, or operable to support a means for transmitting an indication of a requested block decomposition configuration, where the received indication of a block decomposition configuration is based on the transmitted requested block decomposition configuration.

In some examples, the requested block decomposition configuration is associated with a reported rank in the channel state information report.

In some examples, to support transmitting the channel state information report, the throughput component 1045 is capable of, configured to, or operable to support a means for transmitting an indication of a threshold throughput supported by the UE, a threshold bandwidth supported by the UE, or both for one or more of a set of multiple block decomposition configurations, where receiving the indication of the block decomposition configuration is based on transmitting the indication.

In some examples, to support receiving the indication of the block decomposition configuration, the configuration component 1030 is capable of, configured to, or operable to support a means for receiving, based on a quantity of spatial layers exceeding a threshold, an indication of a first block decomposition configuration for a first code word and a second block decomposition configuration for a second code word.

In some examples, the first block decomposition configuration is a same as the second block decomposition configuration based on the quantity of spatial layers being an even number.

In some examples, the first block decomposition configuration, the second block decomposition configuration, or both includes a trivial decomposition in which each of the code block parts of a code block of the set of multiple code blocks is to be transmitted via the first set of time-frequency resources.

Additionally, or alternatively, the communications manager 1020 may support wireless communications in accordance with examples as disclosed herein. In some examples, the code block component 1035 is capable of, configured to, or operable to support a means for receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The decoding component 1040 is capable of, configured to, or operable to support a means for successively decoding the first set of time-frequency resources and the second set of time-frequency resources in accordance with the block decomposition configuration.

In some examples, to support successively decoding the first set of time-frequency resources and the second set of time-frequency resources, the decoding component 1040 is capable of, configured to, or operable to support a means for decoding the first quantity of code block parts associated with the first set of time-frequency resources. In some examples, to support successively decoding the first set of time-frequency resources and the second set of time-frequency resources, the subtraction component 1050 is capable of, configured to, or operable to support a means for subtracting the decoded first quantity of code block parts from a signal carrying the set of multiple code blocks. In some examples, to support successively decoding the first set of time-frequency resources and the second set of time-frequency resources, the decoding component 1040 is capable of, configured to, or operable to support a means for decoding the second quantity of code block parts associated with the second set of time-frequency resources.

In some examples, the subtraction component 1050 is capable of, configured to, or operable to support a means for subtracting the decoded second quantity of code block parts from the signal carrying the set of multiple code blocks. In some examples, the decoding component 1040 is capable of, configured to, or operable to support a means for decoding a third quantity of code block parts associated with a third set of time-frequency resources in accordance with the block decomposition configuration.

In some examples, the throughput component 1045 is capable of, configured to, or operable to support a means for transmitting an indication of a threshold throughput supported by the UE, a threshold bandwidth supported by the UE, or both for one or more of a set of multiple block decomposition configurations, where receiving the set of multiple block codes in accordance with the block decomposition configuration is based on transmitting the indication.

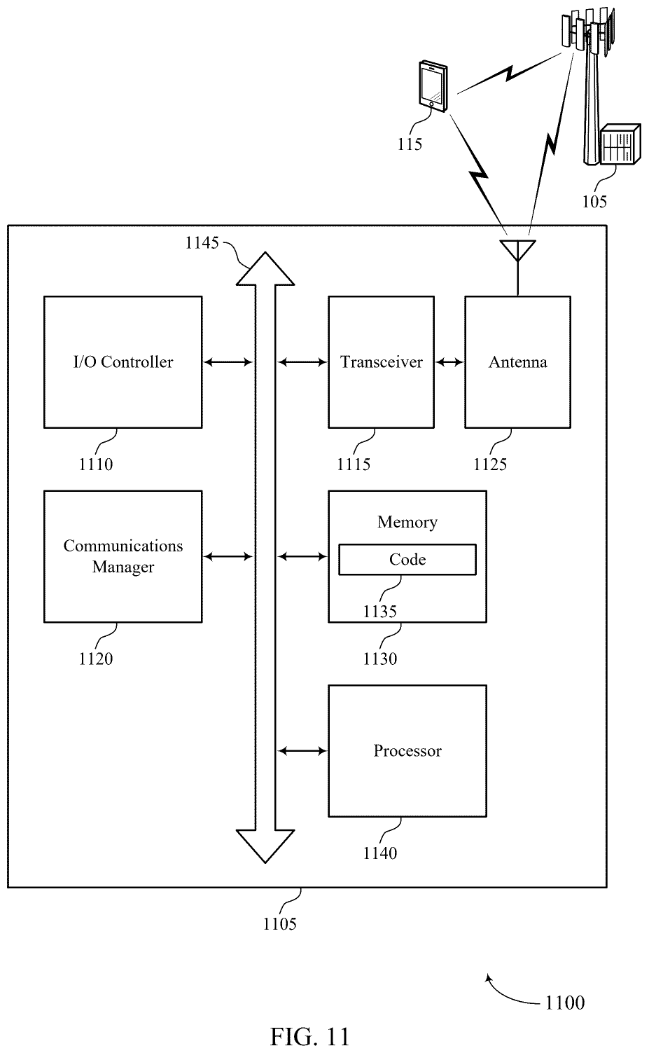

FIG. 11 shows a diagram of a system 1100 including a device 1105 that supports block decomposition configurations for successive interference cancellation in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting block decomposition configurations for successive interference cancellation). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting, to a network entity, a channel state information report. The communications manager 1120 is capable of, configured to, or operable to support a means for receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The communications manager 1120 is capable of, configured to, or operable to support a means for transmitting the set of multiple code blocks in accordance with the block decomposition configuration.

Additionally, or alternatively, the communications manager 1120 may support wireless communications in accordance with examples as disclosed herein. For example, the communications manager 1120 is capable of, configured to, or operable to support a means for receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The communications manager 1120 is capable of, configured to, or operable to support a means for successively decoding the first set of time-frequency resources and the second set of time-frequency resources in accordance with the block decomposition configuration.

By including or configuring the communications manager 1120 in accordance with examples as described herein, the device 1105 may support techniques for reduced latency, improved user experience related to reduced processing, more efficient utilization of communication resources, improved coordination between devices, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of block decomposition configurations for successive interference cancellation as described herein, or the at least one processor 1140 and the at least one memory 1130 may be otherwise configured to, individually or collectively, perform or support such operations.

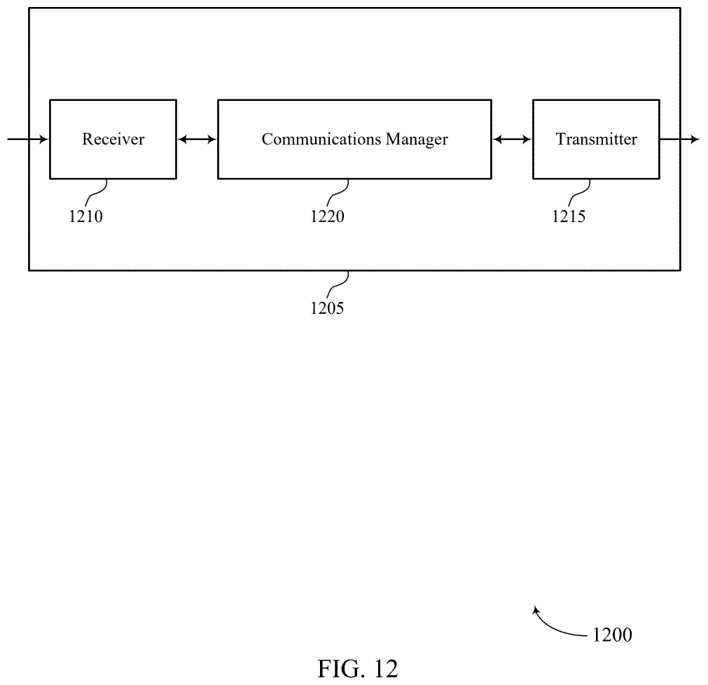

FIG. 12 shows a block diagram 1200 of a device 1205 that supports block decomposition configurations for successive interference cancellation in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of block decomposition configurations for successive interference cancellation as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources. The communications manager 1220 is capable of, configured to, or operable to support a means for outputting the set of multiple code blocks in accordance with the block decomposition configuration.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing and more efficient utilization of communication resources.

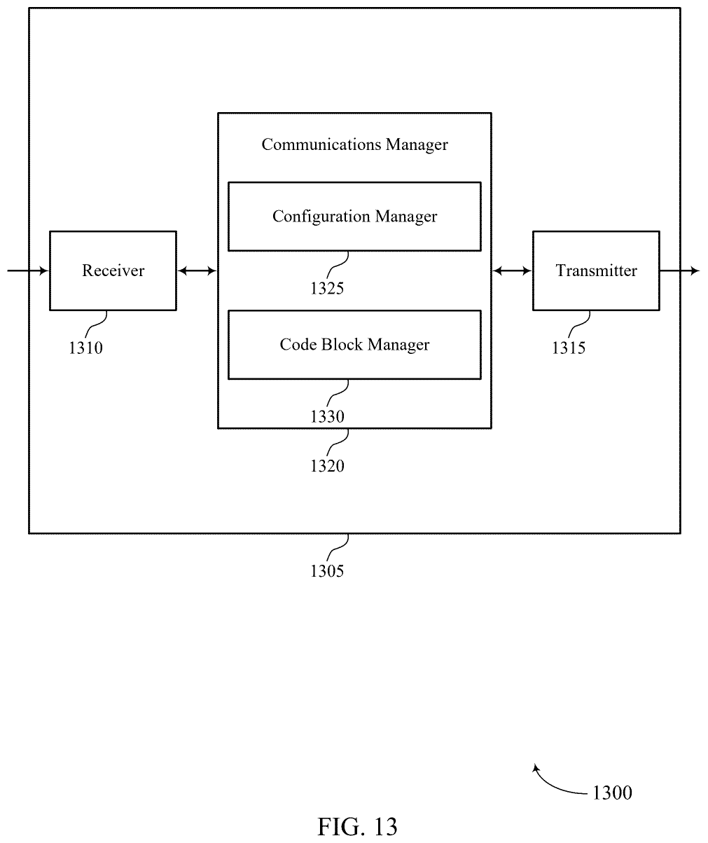

FIG. 13 shows a block diagram 1300 of a device 1305 that supports block decomposition configurations for successive interference cancellation in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of block decomposition configurations for successive interference cancellation as described herein. For example, the communications manager 1320 may include a configuration manager 1325 a code block manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The configuration manager 1325 is capable of, configured to, or operable to support a means for selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources. The code block manager 1330 is capable of, configured to, or operable to support a means for outputting the set of multiple code blocks in accordance with the block decomposition configuration.

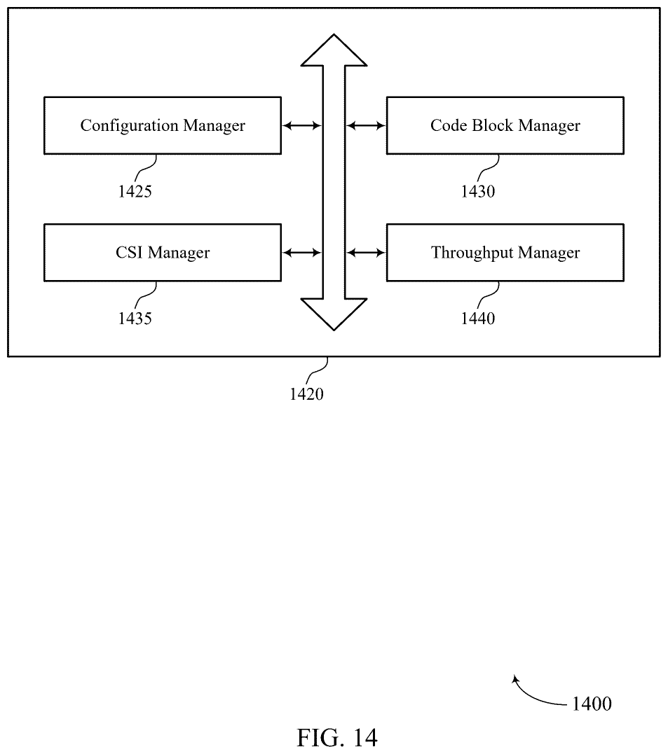

FIG. 14 shows a block diagram 1400 of a communications manager 1420 that supports block decomposition configurations for successive interference cancellation in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of block decomposition configurations for successive interference cancellation as described herein. For example, the communications manager 1420 may include a configuration manager 1425, a code block manager 1430, a CSI manager 1435, a throughput manager 1440, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The configuration manager 1425 is capable of, configured to, or operable to support a means for selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources. The code block manager 1430 is capable of, configured to, or operable to support a means for outputting the set of multiple code blocks in accordance with the block decomposition configuration.

In some examples, to support selecting the block decomposition configuration, the configuration manager 1425 is capable of, configured to, or operable to support a means for selecting the block decomposition configuration from a set of multiple block decomposition configurations associated with a quantity of spatial layers.

In some examples, the set of multiple block decomposition configurations includes a trivial decomposition in which each of the code block parts of a code block of the set of multiple code blocks is to be output via the first set of time-frequency resources.

In some examples, to support selecting the block decomposition configuration, the CSI manager 1435 is capable of, configured to, or operable to support a means for obtaining a channel state information report. In some examples, to support selecting the block decomposition configuration, the configuration manager 1425 is capable of, configured to, or operable to support a means for selecting the block decomposition configuration based on the channel state information report.

In some examples, the configuration manager 1425 is capable of, configured to, or operable to support a means for obtaining an indication of a requested block decomposition configuration, where selecting the block decomposition configuration is based on the indication.

In some examples, the configuration manager 1425 is capable of, configured to, or operable to support a means for outputting an indication of the selected block decomposition configuration via a DCI message, via a medium access control-control element (MAC-CE), or via an RRC message.

In some examples, the throughput manager 1440 is capable of, configured to, or operable to support a means for obtaining, from a UE, an indication of a threshold throughput supported by the UE, a threshold bandwidth supported by the UE, or both for one or more of a set of multiple block decomposition configurations, where the block decomposition configuration is selected based on obtaining the indication.

In some examples, to support selecting the block decomposition configuration, the configuration manager 1425 is capable of, configured to, or operable to support a means for selecting, based on a quantity of spatial layers exceeding a threshold, a first block decomposition configuration for a first code word and a second block decomposition configuration for a second code word.

In some examples, the first block decomposition configuration is a same as the second block decomposition configuration based on the quantity of spatial layers being an even number.

In some examples, the first block decomposition configuration, the second block decomposition configuration, or both includes a trivial decomposition in which each of the code block parts of a code block of the set of multiple code blocks is to be output via the first set of time-frequency resources.

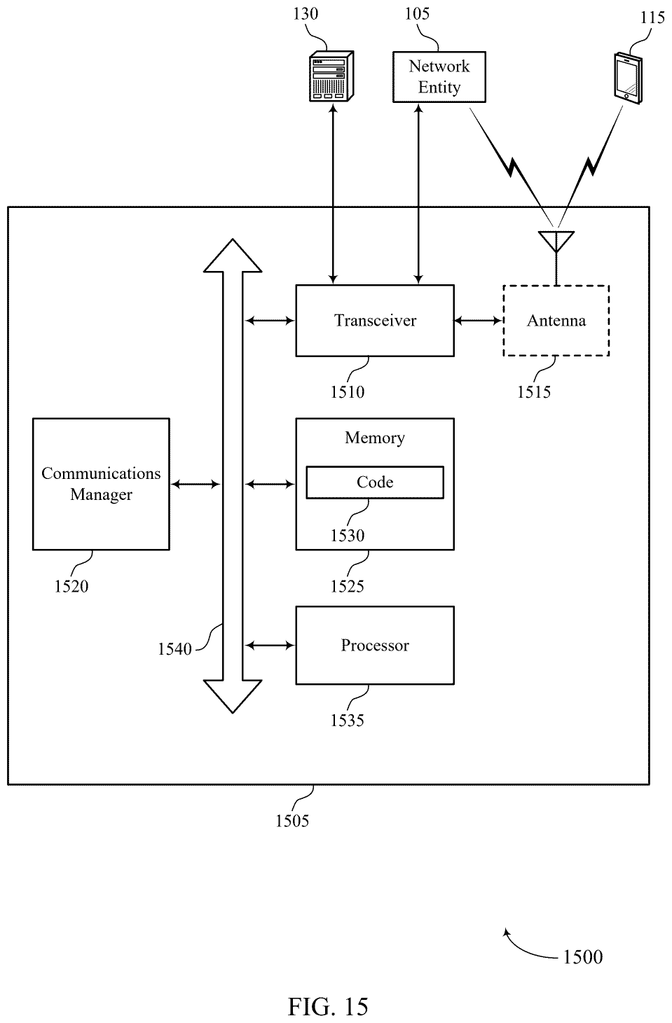

FIG. 15 shows a diagram of a system 1500 including a device 1505 that supports block decomposition configurations for successive interference cancellation in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting block decomposition configurations for successive interference cancellation). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources. The communications manager 1520 is capable of, configured to, or operable to support a means for outputting the set of multiple code blocks in accordance with the block decomposition configuration.

By including or configuring the communications manager 1520 in accordance with examples as described herein, the device 1505 may support techniques for reduced latency, improved user experience related to reduced processing, more efficient utilization of communication resources, improved coordination between devices, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of block decomposition configurations for successive interference cancellation as described herein, or the at least one processor 1535 and the at least one memory 1525 may be otherwise configured to, individually or collectively, perform or support such operations.

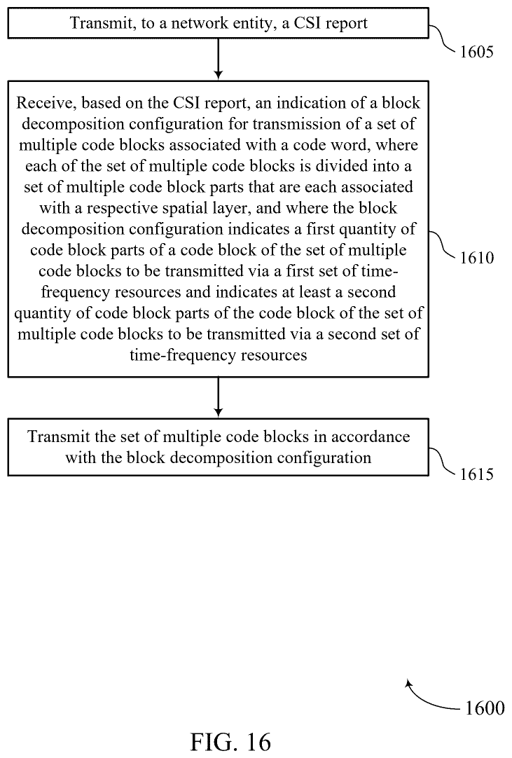

FIG. 16 shows a flowchart illustrating a method 1600 that supports block decomposition configurations for successive interference cancellation in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include transmitting, to a network entity, a channel state information report. The operations of 1605 may be performed in accordance with examples as disclosed herein. In some examples, aspects of the operations of 1605 may be performed by a CSI component 1025 as described with reference to FIG. 10.

At 1610, the method may include receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The operations of 1610 may be performed in accordance with examples as disclosed herein. In some examples, aspects of the operations of 1610 may be performed by a configuration component 1030 as described with reference to FIG. 10.

At 1615, the method may include transmitting the set of multiple code blocks in accordance with the block decomposition configuration. The operations of 1615 may be performed in accordance with examples as disclosed herein. In some examples, aspects of the operations of 1615 may be performed by a code block component 1035 as described with reference to FIG. 10.

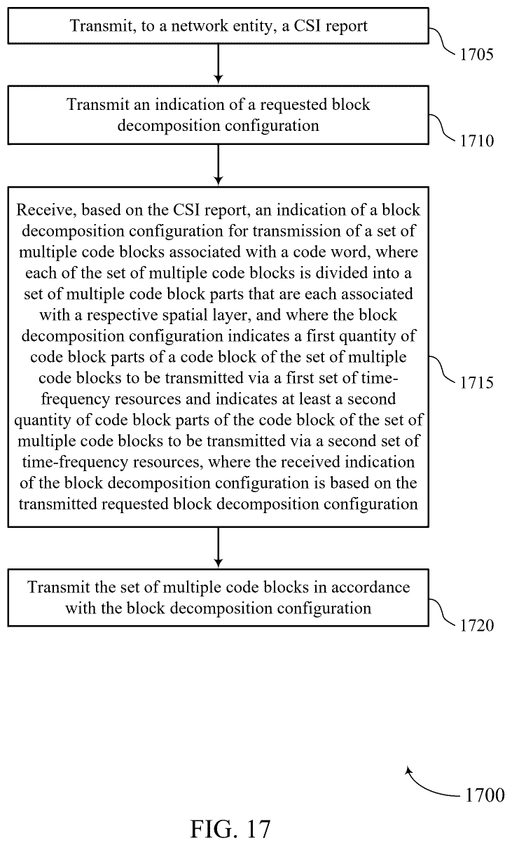

FIG. 17 shows a flowchart illustrating a method 1700 that supports block decomposition configurations for successive interference cancellation in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include transmitting, to a network entity, a channel state information report. The operations of 1705 may be performed in accordance with examples as disclosed herein. In some examples, aspects of the operations of 1705 may be performed by a CSI component 1025 as described with reference to FIG. 10.

At 1710, the method may include transmitting an indication of a requested block decomposition configuration, where the received indication of a block decomposition configuration is based on the transmitted requested block decomposition configuration. The operations of 1710 may be performed in accordance with examples as disclosed herein. In some examples, aspects of the operations of 1710 may be performed by a configuration component 1030 as described with reference to FIG. 10.

At 1715, the method may include receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The operations of 1715 may be performed in accordance with examples as disclosed herein. In some examples, aspects of the operations of 1715 may be performed by a configuration component 1030 as described with reference to FIG. 10.

At 1720, the method may include transmitting the set of multiple code blocks in accordance with the block decomposition configuration. The operations of 1720 may be performed in accordance with examples as disclosed herein. In some examples, aspects of the operations of 1720 may be performed by a code block component 1035 as described with reference to FIG. 10.

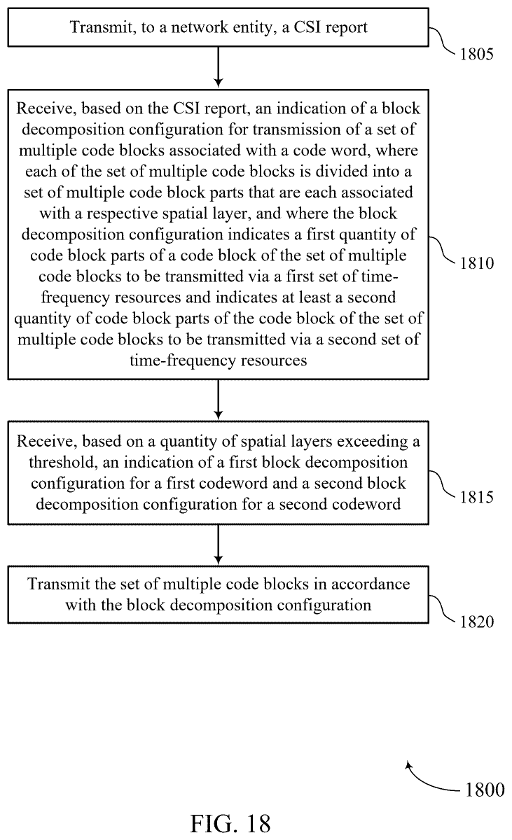

FIG. 18 shows a flowchart illustrating a method 1800 that supports block decomposition configurations for successive interference cancellation in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include transmitting, to a network entity, a channel state information report. The operations of 1805 may be performed in accordance with examples as disclosed herein. In some examples, aspects of the operations of 1805 may be performed by a CSI component 1025 as described with reference to FIG. 10.

At 1810, the method may include receiving, based on the channel state information report, an indication of a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The operations of 1810 may be performed in accordance with examples as disclosed herein. In some examples, aspects of the operations of 1810 may be performed by a configuration component 1030 as described with reference to FIG. 10.

At 1815, the method may include receiving, based on a quantity of spatial layers exceeding a threshold, an indication of a first block decomposition configuration for a first code word and a second block decomposition configuration for a second code word. The operations of 1815 may be performed in accordance with examples as disclosed herein. In some examples, aspects of the operations of 1815 may be performed by a configuration component 1030 as described with reference to FIG. 10.

At 1820, the method may include transmitting the set of multiple code blocks in accordance with the block decomposition configuration. The operations of 1820 may be performed in accordance with examples as disclosed herein. In some examples, aspects of the operations of 1820 may be performed by a code block component 1035 as described with reference to FIG. 10.

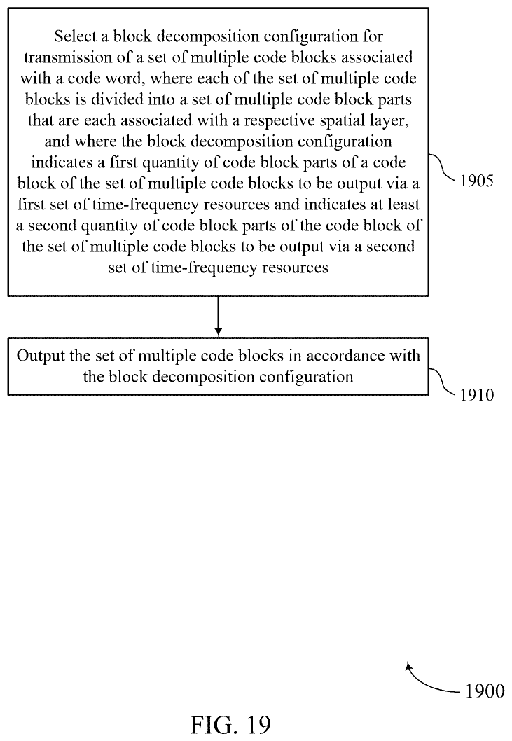

FIG. 19 shows a flowchart illustrating a method 1900 that supports block decomposition configurations for successive interference cancellation in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources. The operations of 1905 may be performed in accordance with examples as disclosed herein. In some examples, aspects of the operations of 1905 may be performed by a configuration manager 1425 as described with reference to FIG. 14.

At 1910, the method may include outputting the set of multiple code blocks in accordance with the block decomposition configuration. The operations of 1910 may be performed in accordance with examples as disclosed herein. In some examples, aspects of the operations of 1910 may be performed by a code block manager 1430 as described with reference to FIG. 14.

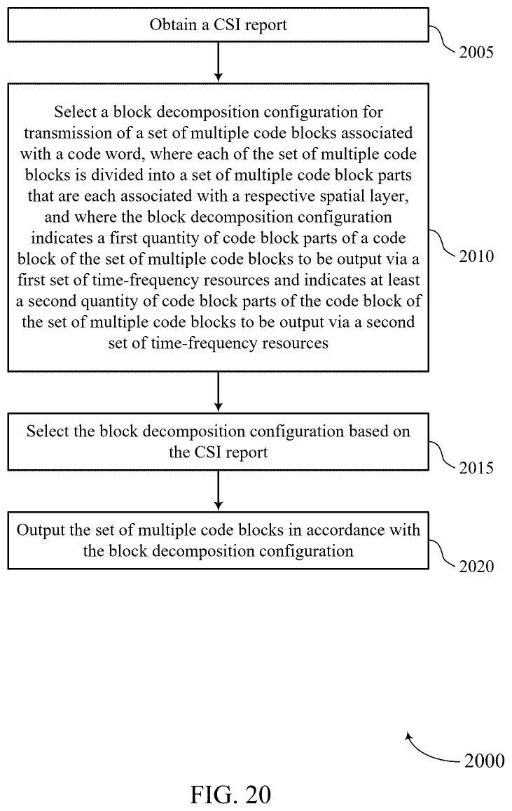

FIG. 20 shows a flowchart illustrating a method 2000 that supports block decomposition configurations for successive interference cancellation in accordance with one or more aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include obtaining a channel state information report. The operations of 2005 may be performed in accordance with examples as disclosed herein. In some examples, aspects of the operations of 2005 may be performed by a CSI manager 1435 as described with reference to FIG. 14.

At 2010, the method may include selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources. The operations of 2010 may be performed in accordance with examples as disclosed herein. In some examples, aspects of the operations of 2010 may be performed by a configuration manager 1425 as described with reference to FIG. 14.

At 2015, the method may include selecting the block decomposition configuration based on the channel state information report. The operations of 2015 may be performed in accordance with examples as disclosed herein. In some examples, aspects of the operations of 2015 may be performed by a configuration manager 1425 as described with reference to FIG. 14.

At 2020, the method may include outputting the set of multiple code blocks in accordance with the block decomposition configuration. The operations of 2020 may be performed in accordance with examples as disclosed herein. In some examples, aspects of the operations of 2020 may be performed by a code block manager 1430 as described with reference to FIG. 14.

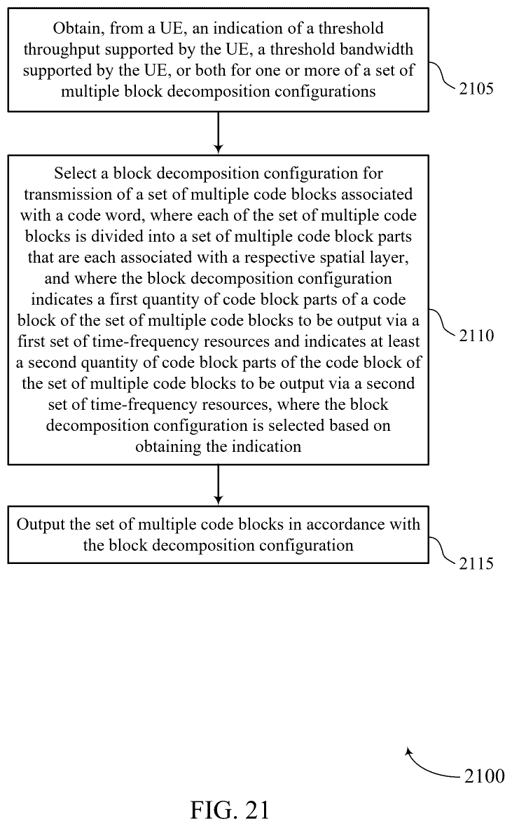

FIG. 21 shows a flowchart illustrating a method 2100 that supports block decomposition configurations for successive interference cancellation in accordance with one or more aspects of the present disclosure. The operations of the method 2100 may be implemented by a network entity or its components as described herein. For example, the operations of the method 2100 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2105, the method may include obtaining, from a UE, an indication of a threshold throughput supported by the UE, a threshold bandwidth supported by the UE, or both for one or more of a set of multiple block decomposition configurations, where the block decomposition configuration is selected based on obtaining the indication. The operations of 2105 may be performed in accordance with examples as disclosed herein. In some examples, aspects of the operations of 2105 may be performed by a throughput manager 1440 as described with reference to FIG. 14.

At 2110, the method may include selecting a block decomposition configuration for transmission of a set of multiple code blocks associated with a code word, where each of the set of multiple code blocks is divided into a set of multiple code block parts that are each associated with a respective spatial layer, and where the block decomposition configuration indicates a first quantity of code block parts of a code block of the set of multiple code blocks to be output via a first set of time-frequency resources and indicates at least a second quantity of code block parts of the code block of the set of multiple code blocks to be output via a second set of time-frequency resources. The operations of 2110 may be performed in accordance with examples as disclosed herein. In some examples, aspects of the operations of 2110 may be performed by a configuration manager 1425 as described with reference to FIG. 14.

At 2115, the method may include outputting the set of multiple code blocks in accordance with the block decomposition configuration. The operations of 2115 may be performed in accordance with examples as disclosed herein. In some examples, aspects of the operations of 2115 may be performed by a code block manager 1430 as described with reference to FIG. 14.

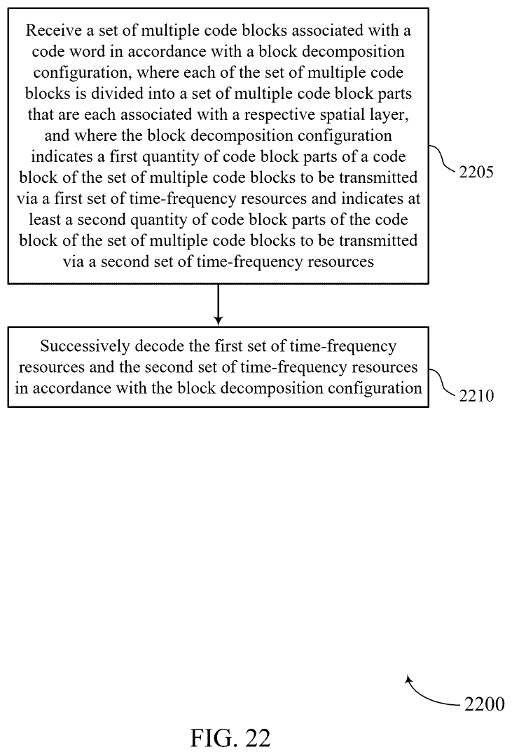

FIG. 22 shows a flowchart illustrating a method 2200 that supports block decomposition configurations for successive interference cancellation in accordance with one or more aspects of the present disclosure. The operations of the method 2200 may be implemented by a UE or its components as described herein. For example, the operations of the method 2200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 2205, the method may include receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The operations of 2205 may be performed in accordance with examples as disclosed herein. In some examples, aspects of the operations of 2205 may be performed by a code block component 1035 as described with reference to FIG. 10.

At 2210, the method may include successively decoding the first set of time-frequency resources and the second set of time-frequency resources in accordance with the block decomposition configuration. The operations of 2210 may be performed in accordance with examples as disclosed herein. In some examples, aspects of the operations of 2210 may be performed by a decoding component 1040 as described with reference to FIG. 10.

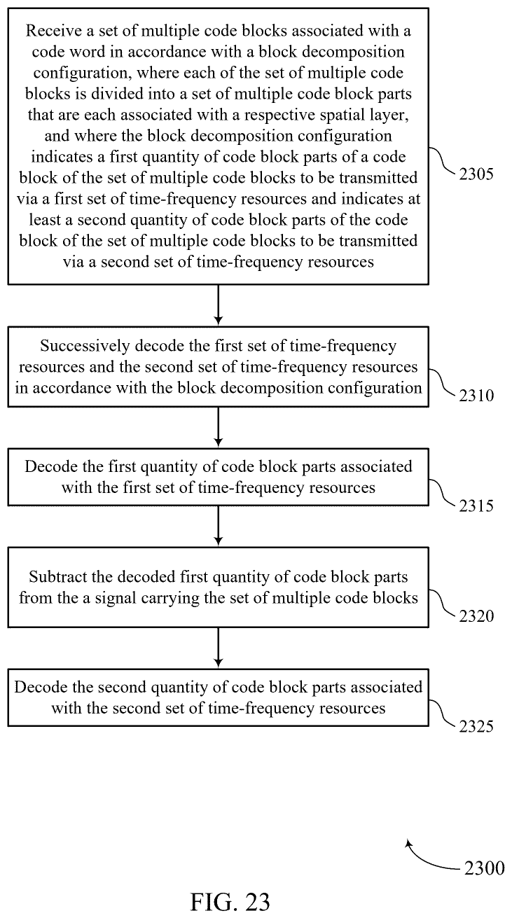

FIG. 23 shows a flowchart illustrating a method 2300 that supports block decomposition configurations for successive interference cancellation in accordance with one or more aspects of the present disclosure. The operations of the method 2300 may be implemented by a UE or its components as described herein. For example, the operations of the method 2300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 2305, the method may include receiving a set of multiple code blocks associated with a code word in accordance with a block decomposition configuration, where each of the set of multiple code blocks is divided into a set of multiple code block parts that are each associated with a respective spatial layer, and where the block decomposition configuration indicates a first quantity of code block parts of a code block of the set of multiple code blocks to be transmitted via a first set of time-frequency resources and indicates at least a second quantity of code block parts of the code block of the set of multiple code blocks to be transmitted via a second set of time-frequency resources. The operations of 2305 may be performed in accordance with examples as disclosed herein. In some examples, aspects of the operations of 2305 may be performed by a code block component 1035 as described with reference to FIG. 10.

At 2310, the method may include successively decoding the first set of time-frequency resources and the second set of time-frequency resources in accordance with the block decomposition configuration. The operations of 2310 may be performed in accordance with examples as disclosed herein. In some examples, aspects of the operations of 2310 may be performed by a decoding component 1040 as described with reference to FIG. 10.

At 2315, the method may include decoding the first quantity of code block parts associated with the first set of time-frequency resources. The operations of 2315 may be performed in accordance with examples as disclosed herein. In some examples, aspects of the operations of 2315 may be performed by a decoding component 1040 as described with reference to FIG. 10.

At 2320, the method may include subtracting the decoded first quantity of code block parts from a signal carrying the set of multiple code blocks. The operations of 2320 may be performed in accordance with examples as disclosed herein. In some examples, aspects of the operations of 2320 may be performed by a subtraction component 1050 as described with reference to FIG. 10.

At 2325, the method may include decoding the second quantity of code block parts associated with the second set of time-frequency resources. The operations of 2325 may be performed in accordance with examples as disclosed herein. In some examples, aspects of the operations of 2325 may be performed by a decoding component 1040 as described with reference to FIG. 10.

The following provides an overview of aspects of the present disclosure:

Aspect 1: A method for wireless communications at a UE, comprising: transmitting, to a network entity, a channel state information report; receiving, based at least in part on the channel state information report, an indication of a block decomposition configuration for transmission of a plurality of code blocks associated with a code word, wherein each of the plurality of code blocks is divided into a plurality of code block parts that are each associated with a respective spatial layer, and wherein the block decomposition configuration indicates a first quantity of code block parts of a code block of the plurality of code blocks to be transmitted via a first set of time-frequency resources and indicates at least a second quantity of code block parts of the code block of the plurality of code blocks to be transmitted via a second set of time-frequency resources; and transmitting the plurality of code blocks in accordance with the block decomposition configuration.

Aspect 2: The method of aspect 1, wherein receiving the indication of the block decomposition configuration further comprises: receiving the indication of the block decomposition configuration via a DCI message, via a medium access control-control element (MAC-CE), or via an RRC message.

Aspect 3: The method of any of aspects 1 through 2, wherein transmitting the channel state information report further comprises: transmitting an indication of a requested block decomposition configuration, wherein the received indication of a block decomposition configuration is based at least in part on the transmitted requested block decomposition configuration.

Aspect 4: The method of aspect 3, wherein the requested block decomposition configuration is associated with a reported rank in the channel state information report.

Aspect 5: The method of any of aspects 1 through 4, wherein transmitting the channel state information report further comprises: transmitting an indication of a threshold throughput supported by the UE, a threshold bandwidth supported by the UE, or both for one or more of a plurality of block decomposition configurations, wherein receiving the indication of the block decomposition configuration is based at least in part on transmitting the indication.

Aspect 6: The method of any of aspects 1 through 5, wherein receiving the indication of the block decomposition configuration further comprises: receiving, based at least in part on a quantity of spatial layers exceeding a threshold, an indication of a first block decomposition configuration for a first codeword and a second block decomposition configuration for a second codeword.

Aspect 7: The method of aspect 6, wherein the first block decomposition configuration is a same as the second block decomposition configuration based at least in part on the quantity of spatial layers being an even number.

Aspect 8: The method of any of aspects 6 through 7, wherein the first block decomposition configuration, the second block decomposition configuration, or both includes a trivial decomposition in which each of the code block parts of a code block of the plurality of code blocks is to be transmitted via the first set of time-frequency resources.

Aspect 9: A method for wireless communications at a network entity, comprising: selecting a block decomposition configuration for transmission of a plurality of code blocks associated with a code word, wherein each of the plurality of code blocks is divided into a plurality of code block parts that are each associated with a respective spatial layer, and wherein the block decomposition configuration indicates a first quantity of code block parts of a code block of the plurality of code blocks to be output via a first set of time-frequency resources and indicates at least a second quantity of code block parts of the code block of the plurality of code blocks to be output via a second set of time-frequency resources; and outputting the plurality of code blocks in accordance with the block decomposition configuration.

Aspect 10: The method of aspect 9, wherein selecting the block decomposition configuration further comprises: selecting the block decomposition configuration from a plurality of block decomposition configurations associated with a quantity of spatial layers.

Aspect 11: The method of aspect 10, wherein the plurality of block decomposition configurations includes a trivial decomposition in which each of the code block parts of a code block of the plurality of code blocks is to be output via the first set of time-frequency resources.

Aspect 12: The method of any of aspects 9 through 11, wherein selecting the block decomposition configuration further comprises: obtaining a channel state information report; and selecting the block decomposition configuration based at least in part on the channel state information report.

Aspect 13: The method of any of aspects 9 through 12, further comprising: obtaining an indication of a requested block decomposition configuration, wherein selecting the block decomposition configuration is based at least in part on the indication.

Aspect 14: The method of any of aspects 9 through 13, further comprising: outputting an indication of the selected block decomposition configuration via a DCI message, via a medium access control-control element (MAC-CE), or via an RRC message.

Aspect 15: The method of any of aspects 9 through 14, further comprising: obtaining, from a UE, an indication of a threshold throughput supported by the UE, a threshold bandwidth supported by the UE, or both for one or more of a plurality of block decomposition configurations, wherein the block decomposition configuration is selected based at least in part on obtaining the indication.

Aspect 16: The method of any of aspects 9 through 15, wherein selecting the block decomposition configuration further comprises: selecting, based at least in part on a quantity of spatial layers exceeding a threshold, a first block decomposition configuration for a first codeword and a second block decomposition configuration for a second codeword.

Aspect 17: The method of aspect 16, wherein the first block decomposition configuration is a same as the second block decomposition configuration based at least in part on the quantity of spatial layers being an even number.

Aspect 18: The method of any of aspects 16 through 17, wherein the first block decomposition configuration, the second block decomposition configuration, or both includes a trivial decomposition in which each of the code block parts of a code block of the plurality of code blocks is to be output via the first set of time-frequency resources.

Aspect 19: A method for wireless communications at a UE, comprising: receiving a plurality of code blocks associated with a code word in accordance with a block decomposition configuration, wherein each of the plurality of code blocks is divided into a plurality of code block parts that are each associated with a respective spatial layer, and wherein the block decomposition configuration indicates a first quantity of code block parts of a code block of the plurality of code blocks to be transmitted via a first set of time-frequency resources and indicates at least a second quantity of code block parts of the code block of the plurality of code blocks to be transmitted via a second set of time-frequency resources; and successively decoding the first set of time-frequency resources and the second set of time-frequency resources in accordance with the block decomposition configuration.

Aspect 20: The method of aspect 19, wherein successively decoding the first set of time-frequency resources and the second set of time-frequency resources further comprises: decoding the first quantity of code block parts associated with the first set of time-frequency resources; subtracting the decoded first quantity of code block parts from the a signal carrying the plurality of code blocks; and decoding the second quantity of code block parts associated with the second set of time-frequency resources.

Aspect 21: The method of aspect 20, further comprising: subtracting the decoded second quantity of code block parts from the signal carrying the plurality of code blocks; and decoding a third quantity of code block parts associated with a third set of time-frequency resources in accordance with the block decomposition configuration.

Aspect 22: The method of any of aspects 19 through 21, further comprising: transmitting an indication of a threshold throughput supported by the UE, a threshold bandwidth supported by the UE, or both for one or more of a plurality of block decomposition configurations, wherein receiving the plurality of block codes in accordance with the block decomposition configuration is based at least in part on transmitting the indication.

Aspect 23: A UE for wireless communications, comprising one or more memories storing processor-executable code, and one or more processors coupled with the one or more memories and individually or collectively operable to execute the code to cause the UE to perform a method of any of aspects 1 through 8.

Aspect 24: A UE for wireless communications, comprising at least one means for performing a method of any of aspects 1 through 8.

Aspect 25: A non-transitory computer-readable medium storing code for wireless communications, the code comprising instructions executable by one or more processors to perform a method of any of aspects 1 through 8.

Aspect 26: A network entity for wireless communications, comprising one or more memories storing processor-executable code, and one or more processors coupled with the one or more memories and individually or collectively operable to execute the code to cause the network entity to perform a method of any of aspects 9 through 18.

Aspect 27: A network entity for wireless communications, comprising at least one means for performing a method of any of aspects 9 through 18.

Aspect 28: A non-transitory computer-readable medium storing code for wireless communications, the code comprising instructions executable by one or more processors to perform a method of any of aspects 9 through 18.

Aspect 29: A UE for wireless communications, comprising one or more memories storing processor-executable code, and one or more processors coupled with the one or more memories and individually or collectively operable to execute the code to cause the UE to perform a method of any of aspects 19 through 22.

Aspect 30: A UE for wireless communications, comprising at least one means for performing a method of any of aspects 19 through 22.

Aspect 31: A non-transitory computer-readable medium storing code for wireless communications, the code comprising instructions executable by one or more processors to perform a method of any of aspects 19 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity, a channel state information report;
receive, based at least in part on the channel state information report, an indication of a block decomposition configuration for transmission of a plurality of code blocks associated with a code word, wherein each of the plurality of code blocks is divided into a plurality of code block parts that are each associated with a respective spatial layer, and wherein the block decomposition configuration indicates a first quantity of code block parts of a code block of the plurality of code blocks to be transmitted via a first set of time-frequency resources and indicates at least a second quantity of code block parts of the code block of the plurality of code blocks to be transmitted via a second set of time-frequency resources; and
transmit the plurality of code blocks in accordance with the block decomposition configuration.

2. The UE of claim 1, wherein, to receive the indication of the block decomposition configuration, the one or more processors are individually or collectively further operable to execute the code to cause the UE to:
receive the indication of the block decomposition configuration via a downlink control information (DCI) message, via a medium access control-control element (MAC-CE), or via a radio resource control (RRC) message.

3. The UE of claim 1, wherein, to transmit the channel state information report, the one or more processors are individually or collectively further operable to execute the code to cause the UE to:
transmit an indication of a requested block decomposition configuration, wherein the received indication of a block decomposition configuration is based at least in part on the transmitted requested block decomposition configuration.

4. The UE of claim 3, wherein the requested block decomposition configuration is associated with a reported rank in the channel state information report.

5. The UE of claim 1, wherein, to transmit the channel state information report, the one or more processors are individually or collectively further operable to execute the code to cause the UE to:
transmit an indication of a threshold throughput supported by the UE, a threshold bandwidth supported by the UE, or both for one or more of a plurality of block decomposition configurations, wherein receiving the indication of the block decomposition configuration is based at least in part on transmitting the indication.

6. The UE of claim 1, wherein, to receive the indication of the block decomposition configuration, the one or more processors are individually or collectively further operable to execute the code to cause the UE to:
receive, based at least in part on a quantity of spatial layers exceeding a threshold, an indication of a first block decomposition configuration for a first code word and a second block decomposition configuration for a second code word.

7. The UE of claim 6, wherein the first block decomposition configuration is a same as the second block decomposition configuration based at least in part on the quantity of spatial layers being an even number.

8. The UE of claim 6, wherein the first block decomposition configuration, the second block decomposition configuration, or both includes a trivial decomposition in which each of the code block parts of a code block of the plurality of code blocks is to be transmitted via the first set of time-frequency resources.

9. A network entity, comprising:
one or more memories storing processor-executable code; and
one or more processors coupled with the one or more memories and individually or collectively operable to execute the code to cause the network entity to:
select a block decomposition configuration for transmission of a plurality of code blocks associated with a code word, wherein each of the plurality of code blocks is divided into a plurality of code block parts that are each associated with a respective spatial layer, and wherein the block decomposition configuration indicates a first quantity of code block parts of a code block of the plurality of code blocks to be output via a first set of time-frequency resources and indicates at least a second quantity of code block parts of the code block of the plurality of code blocks to be output via a second set of time-frequency resources; and
output the plurality of code blocks in accordance with the block decomposition configuration.

10. The network entity of claim 9, wherein, to select the block decomposition configuration, the one or more processors are individually or collectively further operable to execute the code to cause the network entity to:
select the block decomposition configuration from a plurality of block decomposition configurations associated with a quantity of spatial layers.

11. The network entity of claim 10, wherein the plurality of block decomposition configurations includes a trivial decomposition in which each of the code block parts of a code block of the plurality of code blocks is to be output via the first set of time-frequency resources.

12. The network entity of claim 9, wherein, to select the block decomposition configuration, the one or more processors are individually or collectively further operable to execute the code to cause the network entity to:
obtain a channel state information report; and
select the block decomposition configuration based at least in part on the channel state information report.

13. The network entity of claim 9, wherein the one or more processors are individually or collectively further operable to execute the code to cause the network entity to:
obtain an indication of a requested block decomposition configuration, wherein selecting the block decomposition configuration is based at least in part on the indication.

14. The network entity of claim 9, wherein the one or more processors are individually or collectively further operable to execute the code to cause the network entity to:
output an indication of the selected block decomposition configuration via a downlink control information (DCI) message, via a medium access control-control element (MAC-CE), or via a radio resource control (RRC) message.

15. The network entity of claim 9, wherein the one or more processors are individually or collectively further operable to execute the code to cause the network entity to:
obtain, from a user equipment (UE), an indication of a threshold throughput supported by the UE, a threshold bandwidth supported by the UE, or both for one or more of a plurality of block decomposition configurations, wherein the block decomposition configuration is selected based at least in part on obtaining the indication.

16. The network entity of claim 9, wherein, to select the block decomposition configuration, the one or more processors are individually or collectively further operable to execute the code to cause the network entity to:
select, based at least in part on a quantity of spatial layers exceeding a threshold, a first block decomposition configuration for a first code word and a second block decomposition configuration for a second code word.

17. The network entity of claim 16, wherein the first block decomposition configuration is a same as the second block decomposition configuration based at least in part on the quantity of spatial layers being an even number.

18. A user equipment (UE), comprising:
one or more memories storing processor-executable code; and
one or more processors coupled with the one or more memories and individually or collectively operable to execute the code to cause the UE to:
receive a plurality of code blocks associated with a code word in accordance with a block decomposition configuration, wherein each of the plurality of code blocks is divided into a plurality of code block parts that are each associated with a respective spatial layer, and wherein the block decomposition configuration indicates a first quantity of code block parts of a code block of the plurality of code blocks to be transmitted via a first set of time-frequency resources and indicates at least a second quantity of code block parts of the code block of the plurality of code blocks to be transmitted via a second set of time-frequency resources; and
successively decode the first set of time-frequency resources and the second set of time-frequency resources in accordance with the block decomposition configuration.

19. The UE of claim 18, wherein, to successively decode the first set of time-frequency resources and the second set of time-frequency resources, the one or more processors are individually or collectively further operable to execute the code to cause the UE to:
decode the first quantity of code block parts associated with the first set of time-frequency resources;
subtract the decoded first quantity of code block parts from a signal carrying the plurality of code blocks; and
decode the second quantity of code block parts associated with the second set of time-frequency resources.

20. The UE of claim 19, wherein the one or more processors are individually or collectively further operable to execute the code to cause the UE to:
subtract the decoded second quantity of code block parts from the signal carrying the plurality of code blocks; and
decode a third quantity of code block parts associated with a third set of time-frequency resources in accordance with the block decomposition configuration.
